(19) United States
(12) Patent Application Publication
(10) Pub. No.: US 2026/0203116 A1
(43) Pub. Date: Jul. 16, 2026

(54) DYNAMIC ENHANCEMENT OF ENERGY CONSUMPTION OF DISAGGREGATED RADIO ACCESS NETWORK FOR BASE-BAND PROCESSING

(71) Applicant: Dell Products L.P., Round Rock, TX (US)

(72) Inventors: Neeraj Sharma, Fremont, CA (US); Abdul Khader Thakkadi Mohamed Kalvath, Pleasanton, CA (US); Deepak Ladwa, Fremont, CA (US); Vishal Mahajan, BENGALURU (IN)

(21) Appl. No.: 19/019,407

(22) Filed: Jan. 13, 2025

(51) Int. Cl. G06F 9/50

(52) U.S. Cl. CPC G06F 9/5027; G06F 9/5094; G06F 2209/501

(57) ABSTRACT

Management of processing unit cores (PUCs) of RAN can be enhanced. Processor manager (PM) can determine conditions relating to attributes based on attribute information from monitoring attributes associated with RAN. Based on conditions, condition trend, or predicted conditions, PM can determine whether modification is to be made to PUC allocation or operational states to ensure QoS associated with RAN can be satisfied with lowest RAN energy consumption. If PM determines that increase modification to increase number of PUCs allocated or operational states of PUCs can be desired to satisfy QoS, PM can perform increase modification wherein RAN can have lowest energy consumption while satisfying QoS. If PM determines that decrease modification can be performed to decrease number of PUCs allocated or operational states of PUCs to reduce RAN energy consumption while satisfying QoS, PM can perform decrease modification wherein RAN can have lowest energy consumption while satisfying QoS.

### BACKGROUND

Communication networks can enable users to use devices to wirelessly connect to a communication network and communicate with other devices (e.g., wireless devices or other communication devices). A device, such as a mobile device (e.g., smart phone or other mobile wireless device) can connect (e.g., wirelessly connect) to a cell (e.g., cell of a base station) or other access point associated with a radio access network (RAN) to facilitate connection to a communication network. Devices, via connection to the RAN and communication network, can utilize various types of services and applications of or associated with the communication network.

The above-described description is merely intended to provide a contextual overview regarding communication systems, and is not intended to be exhaustive.

### SUMMARY

The following presents a simplified summary in order to provide a basic understanding of some aspects described herein. This summary is not an extensive overview of the disclosed subject matter. It is intended to neither identify key or critical elements of the disclosure nor delineate the scope thereof. Its sole purpose is to present some concepts in a simplified form as a prelude to the more detailed description that is presented later.

In some embodiments, the disclosed subject matter can comprise a method that can comprise analyzing, by a system comprising at least one processor, attribute information relating to a group of attributes relating to conditions associated with a base station. The method also can comprise controlling, by the system, allocation of respective processing unit cores of a group of processing unit cores associated with the base station for use in performing base station functions based on a result of the analyzing, wherein the result can indicate an amount of energy consumption by the base station and can indicate whether a quality of service value associated with the base station satisfies a defined threshold quality of service value.

In certain embodiments, the disclosed subject matter can comprise a system that can comprise at least one memory that can store computer executable components, and at least one processor that can execute computer executable components stored in the at least one memory. The computer executable components can comprise a condition detector that can analyze attribute data relating to a group of attributes relating to conditions associated with radio access network equipment, and, based on a result of the analysis of the attribute data, determine the conditions associated with the radio access network equipment. The computer executable components also can comprise a processor manager that can control allocation of respective processing unit cores of a group of processing unit cores of at least one processing unit associated with the radio access network equipment for use in performing radio access network functions based on the conditions, wherein the conditions can indicate an amount of power consumption by the radio access network equipment and can indicate whether a quality of service metric associated with the base station satisfies a defined threshold quality of service metric.

In still other embodiments, the disclosed subject matter can comprise a non-transitory machine-readable medium, comprising executable instructions that, when executed by at least one processor, can facilitate performance of operations. The operations can comprise evaluating characteristic data relating to a group of characteristics relating to conditions associated with a distributed unit of a radio access network. The operations also can comprise managing utilization of respective processing unit cores of a group of processing unit cores associated with the distributed unit for use in performing radio access network operations based on a result of the evaluating, wherein the result can indicate an amount of power consumption by the distributed unit and can indicate whether a quality of service measurement associated with the radio access network satisfies a function of a defined threshold quality of service.

The following description and the annexed drawings set forth in detail certain illustrative aspects of the subject disclosure. These aspects are indicative, however, of but a few of the various ways in which the principles of various disclosed aspects can be employed and the disclosure is intended to include all such aspects and their equivalents. Other advantages and features will become apparent from the following detailed description when considered in conjunction with the drawings.

### BRIEF DESCRIPTION OF THE DRAWINGS

FIG. 1 illustrates a block diagram of a non-limiting example system that can desirably manage resources, including processing unit cores, associated with a radio access network (RAN) to facilitate satisfying a quality of service (QoS) associated with the RAN while also utilizing a desirably lower amount of energy, in accordance with various aspects and embodiments of the disclosed subject matter.

FIG. 2 depicts a block diagram of a non-limiting example process and information flow that can desirably manage resources, including processing unit cores, associated with a RAN to facilitate satisfying QoS associated with the RAN while also utilizing a desirably lower amount of energy, in accordance with various aspects and embodiments of the disclosed subject matter.

FIG. 3 depicts a diagram of an example graph that can illustrate relative energy consumption of the RAN as spectrum and/or cells of the RAN are activated or deactivated, in accordance with various aspects and embodiments of the disclosed subject matter.

FIG. 4 presents a diagram of an example graph that can illustrate the spectrum enabled versus layer 1 (L1) latencies of the RAN, in accordance with various aspects and embodiments of the disclosed subject matter.

FIG. 5 depicts a diagram of an example graph that can illustrate spectrum utilized by the RAN versus spectrum enabled on the RAN, in accordance with various aspects and embodiments of the disclosed subject matter.

FIG. 6 presents a diagram of an example graph that can illustrate spectrum utilized by the RAN versus a midhaul data rate of the RAN, in accordance with various aspects and embodiments of the disclosed subject matter.

FIG. 7 depicts a diagram of an example graph that can illustrate total spectrum activated by the RAN versus total number of processing unit cores granted by the RAN, in accordance with various aspects and embodiments of the disclosed subject matter.

FIG. 8 depicts a diagram of an example graph that can illustrate processing unit core utilization by the RAN versus the number of processing unit cores granted for the RAN, in accordance with various aspects and embodiments of the disclosed subject matter.

FIG. 9 presents a diagram of an example graph that can illustrate processing unit core utilization by the RAN versus L1 layer latencies associated with the RAN, in accordance with various aspects and embodiments of the disclosed subject matter.

FIG. 10 illustrates a diagram of an example graph of perceived normalized QoS associated with the RAN versus granted processing unit cores of the RAN, in accordance with various aspects and embodiments of the disclosed subject matter.

FIG. 11 depicts a block diagram of a processor manager component, in accordance with various aspects and embodiments of the disclosed subject matter.

FIG. 12 depicts a block diagram of non-limiting example system that can comprise the processor manager component in the RAN in an open RAN (O-RAN) communication network environment to facilitate desirable management of resources, including processing unit cores, associated with the RAN to facilitate satisfying QoS associated with the RAN while also having the RAN utilize a desirably lower amount of energy, in accordance with various aspects and embodiments of the disclosed subject matter.

FIG. 13 depicts a diagram of a non-limiting example base station that can desirably facilitate connections and communication of information associated with devices, in accordance with various aspects and embodiments of the disclosed subject matter.

FIG. 14 illustrates a diagram of a non-limiting example device that can be operable to engage in a system architecture that facilitates wireless communications according to one or more embodiments described herein, in accordance with various aspects and embodiments of the disclosed subject matter.

FIG. 15 illustrates a flow chart of an example method that can desirably manage resources, including processing unit cores, associated with the RAN to facilitate satisfying QoS associated with the RAN while also having the RAN utilize a desirably lower amount of energy, in accordance with various aspects and embodiments of the disclosed subject matter.

FIG. 16 depicts a flow chart of another example method that can desirably manage resources, including processing unit cores, associated with the RAN to facilitate satisfying QoS associated with the RAN while also having the RAN utilize a desirably lower amount of energy, in accordance with various aspects and embodiments of the disclosed subject matter.

FIG. 17 illustrates an example block diagram of an example computing environment in which the various embodiments of the embodiments described herein can be implemented.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

This disclosure relates generally to systems, mechanisms, methods, and techniques that can enhance (e.g., dynamically and enhancedly manage and reduce) energy consumption of a disaggregated radio access network (RAN) for baseband processing. With existing technology, a legacy baseband unit (BBU) can be purpose-built, power efficient hardware that can be used in the public wireless markets. However, the wireless industry has some concern regarding vendor lock-in and supply chain risks with regard to legacy BBUs. In 5^{th} generation (5G) new radio (NR), a disaggregated RAN hosted on a general purpose processor (GPP)-based server can be considered as a potential alternative to legacy BBUs to alleviate the vendor lock-in and supply chain risks associated with legacy BBUs and advance innovations. A significant challenge for adoption of a 5G disaggregated RAN hosted on GPP-based server can be to have such 5G disaggregated RAN hosted on a GPP-based server be either at par in energy efficiency or more energy efficient as compared to legacy BBUs. Due to such challenge, while a disaggregated RAN hosted on a GPP-based server can be considered as a potential alternative to legacy BBUs, the use of a GPP-based server to host a disaggregated RAN has not been able to be utilized or to penetrate the markets as expected because of energy consumption concerns associated with using GPP-based servers to host disaggregated RANs.

It can be desirable (e.g., suitable, beneficial, advantageous, useful, improved, or optimal) for there to be a mechanism and techniques that can be employed to enhance the energy efficiency of a disaggregated RAN hosted on a GPP-based server such that it can be at least on par in energy efficiency or more energy efficient as compared to legacy BBUs. Accordingly, the disclosed subject matter can address and overcome the aforementioned deficiencies and other deficiencies of the existing systems and techniques.

To that end, techniques that can desirably (e.g., automatically, dynamically, suitably, reliably, efficiently, enhancedly, and/or optimally) manage resources, including processing unit cores of one or more processing units, of a RAN (e.g., disaggregated RAN) for baseband processing, and other functions and operations of the RAN, are presented. A system can comprise a communication network that can comprise one or more RANs. A RAN can comprise one or more base stations that can facilitate communication (e.g., wireless communication) of data between devices associated with the communication network (e.g., communicatively connected to a base station of the communication network, or otherwise connected to the communication network). In some embodiments, the RAN can be a disaggregated RAN that can comprise one or more distributed units (DUs), a central unit (CU), and/or other components, such as described herein.

The communication network can comprise a core network that can be associated with (e.g., communicatively connected to) the one or more RANs. The core network can comprise various network functions, components, and equipment that can facilitate communication (e.g., wireless communication) of information (e.g., voice traffic, data traffic) to or from devices (e.g., communication devices) associated with (e.g., wirelessly connected to) the core network or another network of the communication network.

The RAN can comprise or can be associated with a processor manager component that can desirably (e.g., automatically, dynamically, suitably, reliably, efficiently, enhancedly, and/or optimally) manage (e.g., control) allocation, use, and/or operational states of respective resources, including respective processing unit cores of a group of processing unit cores of one or more processing units (e.g., one or more CPUs or GPP-based servers) the RAN (e.g., group of processing unit cores associated with the one or more DUs and/or other component of the RAN) to facilitate achieving and maintaining a desired quality of service (QoS) associated with the RAN (e.g., perceived QoS for voice and data traffic associated with devices associated with the RAN) while also conserving (e.g., reducing or minimizing) consumption of energy by the RAN in connection with performing baseband processing and/or other functions and operations of the RAN. The group of processing unit cores can comprise a desired number (e.g., 8, 16, 32, 64, or other desired number greater or less than 64) of processing unit cores.

The processor manager component can monitor respective attributes of a group of attributes that can relate to the RAN, the group of processing unit cores, and/or devices associated with the RAN. The group of attributes can comprise or relate to, for example, a duplex type associated with communication of data between the RAN and a device, an active spectrum associated with the RAN, a spectrum utilization associated with the RAN, a spectral efficiency associated with the RAN, a transmission time interval (TTI) (or time to interval) associated with the RAN, a number of the respective processing unit cores allocated by the RAN, a level of utilization of the respective processing unit cores, an overall layer 1 (L1) latency associated with the RAN, respective operational states of respective unallocated processing unit cores of the group of processing unit cores, a frequency associated with the group of processing unit cores, midhaul incoming and outgoing data traffic to and from the RAN, a number of devices being scheduled per the TTI, a QoS (e.g., perceived QoS) associated with the RAN and/or device(s) associated therewith, and/or another desired attribute. Based at least in part on the monitoring, the processor manager component can obtain and/or collect attribute information relating to respective conditions associated with the respective attributes from various components, devices, and/or sensors of or associated with the RAN. Based at least in part on the results of analyzing the attribute information, the processor manager component can determine or detect the respective conditions associated with the respective attributes. In accordance with various embodiments, based at least in part on the respective conditions and/or respective previous conditions associated with the respective attributes, and/or other information (e.g., event information relating to an event associated with and/or in proximity to the RAN), the processor manager component can determine the respective conditions, respective condition trends (e.g., one or more respective trends of one or more respective conditions), and/or respective predicted conditions (e.g., one or more predictions of one or more respective conditions at a future time).

Based at least in part on the respective conditions, the respective condition trends, and/or the respective predicted conditions, and/or a defined threshold (e.g., threshold minimum) amount of condition change (e.g., which can indicate whether a modification relating to the group of processing unit cores can be performed), the processor manager component can determine whether modification is to be made to allocation of respective processing unit cores and/or respective operational states of the respective processing unit cores to ensure that QoS associated with the RAN can be satisfied (e.g., can satisfy a defined threshold minimum QoS level or value) while also enabling the RAN to utilize (e.g., consume) a desirably lower (e.g., reduced, lowest, or minimized) amount of energy (e.g., power), in accordance with defined processor management criteria. If the processor manager component determines that the defined threshold amount of condition change for triggering (e.g., initiating) modification has been satisfied, and determines that a modification (e.g., an increase modification) can be desired (e.g., wanted, useful, or needed) to increase the number of processing unit cores allocated (e.g., for baseband processing or other RAN-related functions or operations) and/or increase (e.g., raise) respective operational states of the respective processing unit cores (e.g., at least some of the respective processing unit cores) to achieve and/or maintain QoS that can satisfy the defined threshold QoS, the processor manager component can determine and perform the modification such that the RAN can have a desirably lower (e.g., reduced, lowest, or minimal) amount of energy consumption while still satisfying the QoS. If, instead, the processor manager component determines that the defined threshold amount of condition change for triggering modification has been satisfied, and determines that a modification (e.g., decrease modification) can be performed to decrease number of processing unit cores allocated and/or decrease (e.g., lower) respective operational states of the respective processing unit cores (e.g., at least some of the respective processing units) to reduce energy consumption by the RAN while still satisfying the QoS, the processor manager component can determine and perform the modification such that the RAN can have the desirably lower (e.g., reduced, lowest, or minimal) amount of energy consumption while still satisfying the QoS.

The processing manager component can continue to monitor and perform modifications to the allocation and/or respective operational states of the respective processing unit cores on a desired periodic basis (e.g., after a defined time period has elapsed since a last evaluation of whether there is to be a modification) or dynamically (e.g., in response to detection of a modification triggering event). In some embodiments, after performing a modification evaluation, the processor manager component can transition from an active mode to an inactive (e.g., lower power or sleep mode) for the defined time period or until a modification triggering event (if any) is detected.

The disclosed subject matter, by employing the processor manager component and the enhanced techniques described herein, can desirably (e.g., automatically, dynamically, suitably, reliably, efficiently, enhancedly, and/or optimally) manage allocation and/or operational states of processing unit cores to reduce or minimize power consumption by the RAN (e.g., by the DU(s) and/or other components of the RAN) while still desirably achieving and maintaining QoS (e.g., perceived QoS) associated with the RAN (e.g., for voice and data traffic associated with devices associated with the RAN) that can satisfy the defined threshold QoS. The disclosed subject matter, by employing the processor manager component and the enhanced techniques described herein, can thereby provide enhanced performance of the RAN, as compared to existing techniques, and can enable the RAN to have enhanced energy efficiency that at least can be on par with or better than legacy BBUs (e.g., dedicated or purpose-built legacy BBU hardware), while using non-dedicated processing units, such as CPUs or GPP-based servers.

These and other aspects and embodiments of the disclosed subject matter will now be described with respect to the drawings.

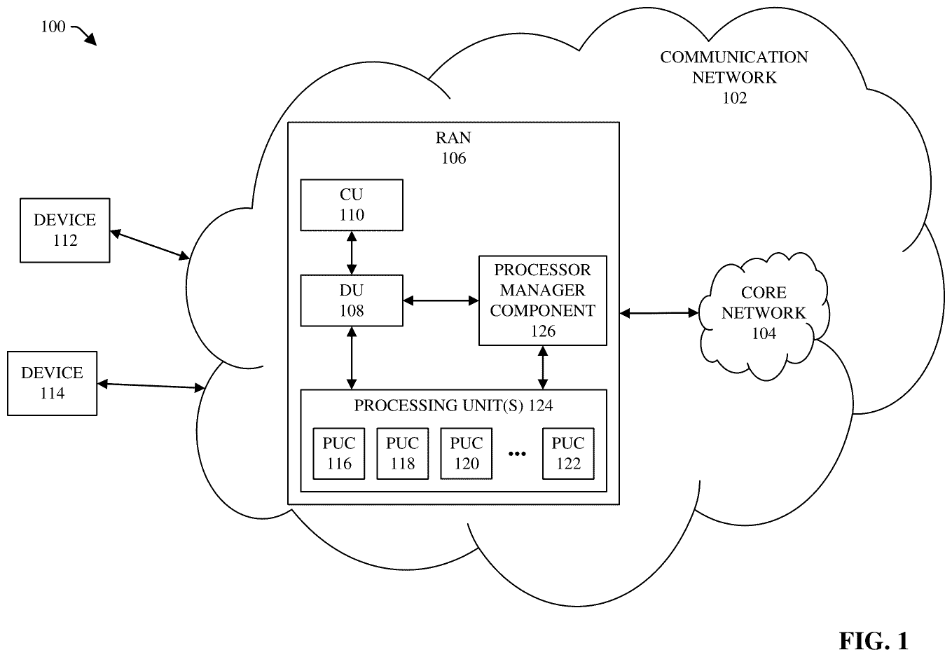

Referring now to the drawings, FIG. 1 illustrates a block diagram of a non-limiting example system 100 that can desirably (e.g., automatically, dynamically, suitably, reliably, efficiently, enhancedly, and/or optimally) manage resources, including processing unit cores, associated with a RAN to facilitate satisfying QoS associated with the RAN while also utilizing (e.g., consuming) a desirably lower (e.g., reduced, lowest, or minimized) amount of energy, in accordance with various aspects and embodiments of the disclosed subject matter. The system 100 can comprise a communication network 102 that can comprise a core network 104 and one or more radio access networks (RANs), such as RAN 106, that can be associated with (e.g., communicatively connected to) the core network 104. Each RAN (e.g., RAN 106) can comprise one or more base stations that each can comprise one or more cells (not shown in FIG. 1). In some embodiments, the RAN 106 can be a disaggregated RAN that can comprise one or more distributed units (DUs), such as DU 108, and a central unit (CU) 110, wherein the one or more DUs (e.g., 108) can be associated with (e.g., communicatively connected to) the CU 110, and wherein the CU 110 can be in one location (e.g., geographic, physical, and/or logical location) and the one or more DUs can be in one or more other locations. The CU 110 can handle, for example, a Layer 3 (L3) layer of RAN processing, among other functions the CU 110 can have. The DU 108 can handle, for example, a Layer 2 (L2) layer (e.g., data traffic scheduler for devices (e.g., UEs)) and the L1 layer (e.g., baseband processing) of the RAN processing.

The core network 104, the one or more RANs (e.g., RAN 106), the one or more base stations, and the one or more cells can facilitate (e.g., enable) wireless communication of data (e.g., voice or other audio data, video data, textual data, or other data) between devices (e.g., communication devices or UEs), such as devices associated with the core network 104, via the one or more RANs, one or more base stations, and one or more cells, and other devices associated with the core network 104 or, more generally, the communication network 102 (e.g., a device, such as a server or computer, can be connected to the communication network 102 via a wireline connection or via a network other than the core network 104).

The devices can comprise, for example, devices 112 and/or 114. A device (e.g., 112 or 114) can be, for example, a wireless, mobile, or smart phone, a computer, a laptop computer, a server, an electronic pad or tablet, a virtual assistant (VA) device, electronic eyewear, an electronic watch, or other electronic bodywear, an electronic gaming device, an Internet of Things (IoT) device (e.g., a health monitoring device, a toaster, a coffee maker, blinds, a music player, speakers, a telemetry device, a smart meter, a machine-to-machine (M2M) device, or other type of IoT device), a device of a connected vehicle (e.g., car, airplane, train, rocket, and/or other at least partially automated vehicle (e.g., drone)), a personal digital assistant (PDA), a dongle (e.g., a universal serial bus (USB) or other type of dongle), a communication device, or other type of device. In some embodiments, the non-limiting term UE can be used to describe the device. The device (e.g., 112 or 114) can be associated with (e.g., communicatively connected to) the communication network 102 via a communication connection and channel, which can include a wireless or wireline communication connection and channel.

In accordance with various embodiments, the core network 104 can comprise various network components that can facilitate wireless communication of data. In some embodiments, the RAN 106 can be a 5G or other NR RAN (e.g., gNB or other NR-type or xG RAN, wherein x can be a number greater than 5), and/or the base station(s) can be a 5G or other NR base station (e.g., gNB or other NR-type or xG base station, wherein x can be a number greater than 5). In some embodiments, the RAN 106 can be an open RAN (O-RAN) that can be part of an O-RAN architecture and environment (e.g., the communication network 102 can employ an O-RAN architecture and environment). In certain embodiments, the core network 104 can comprise a user plane function (UPF) (also can be referred to as a UPF node), an application function (AF) (also can be referred to as an AF node), an application server, an access and mobility management function (AMF), and/or other network functions (not shown in FIG. 1 for reasons of brevity and clarity). The UPF can connect to or interface with the one or more RANs (e.g., RAN 106) and the one or more base stations, can be an interconnect point between the core network 104 and a data network (DN), can provide or facilitate providing a protocol data unit (PDU) session anchor point for providing mobility associated with radio access technologies (RATs), can provide or facilitate providing data packet routing or forwarding, and/or can perform or manage other functions.

The AF, which can be a control plane function, can be associated with, and can act as or fulfill all or part of the role of, the application server, and can interact and communicate with other network functions, including control plane functions, of the core network 104. The AF and associated application server can facilitate (e.g., enable) provision of various services (e.g., voice services, messaging services, media streaming services, Internet and intranet services, multimedia conferencing and collaboration services, or other services) and applications to devices associated with the core network 104. In some embodiments, some of the services can be low latency services and/or network edge services. The AF can comprise one or more AFs that respectively can be owned or managed by the network operator of the core network 104 or by third parties (e.g., trusted third parties). In some embodiments, the UPF can be associated with, and can interact and communicate with, the AF and/or other network functions (e.g., other control plane functions) via a service-based interface (SBI).

The AMF node can be a control plane function that can manage registration and deregistration of devices (e.g., devices 112 and/or 114) with the core network 104, manage connections of devices with the core network 104, manage mobility associated with devices (e.g., maintain knowledge of locations of devices, update locations of devices), and/or manage or perform other functions. In accordance with various other embodiments, the RAN(s) (e.g., RAN 106) and/or the base station(s) can comprise both 4^{th} generation (4G) long term evolution (LTE) technology and functions, and 5G or other NR-type or xG technology and functions.

The communication network 102, more generally, or the core network 104 can comprise various other network equipment (e.g., routers, gateways, transceivers, switches, access points, network functions, processor components, data stores, or other devices or network nodes) that facilitate (e.g., enable) communication of information between respective items of network equipment of the communication network 102, and/or communication of information between the one or more devices (e.g., devices 112 and/or 114) and the communication network 102. The communication network 102, including the core network 104, can provide or facilitate wireless or wireline communication connections and channels between the one or more devices (e.g., devices 112 and/or 114), and/or respectively associated services or applications, and the communication network 102. For reasons of brevity or clarity, some of the various network equipment, components, functions, or devices of the communication network may not be explicitly shown or described herein.

At various times, the respective devices (e.g., devices 112 and/or 114) can utilize respective services. The services can comprise or relate to, for example, voice service (e.g., conversational voice services or other voice services), video streaming service, conversational video service, buffered video service, audio streaming service, other type of streaming service, text or messaging service, data service, control message service (e.g., control message service relating to control of communication network functions and operations), signaling service, real time gaming service, interactive gaming service, transmission control protocol (TCP) service, control message service relating to automated or semi-automated vehicles or motorized devices, law enforcement-related service, medical-related service, emergency-related service, military-related service, background traffic service, or other desired types of service. In some embodiments, a service can be an extended reality (XR) service or other type of service that can involve or relate to communication of data bursts comprising PDU sets.

The RAN 106 can comprise various types of resources, including a group of processing unit cores, comprising processing unit core (PUC) 116, processing unit core 118, processing unit core 120, and processing unit core 122, wherein the group of processing unit cores can perform baseband processing and other functions and operations of the RAN 106. The group of processing unit cores can be part of one or more processing units 124, wherein each of the one or more processing units 124 can comprise one or more of the processing unit cores. In accordance with various embodiments, depending in part on the type of RAN, the number of processing unit cores in the group of processing unit cores can vary, for example, from 8 processing unit cores, 16 processing unit cores, 32 processing unit cores, 64 processing unit cores, or another number of processing unit cores that can be greater than or less than 64. In some embodiments, the one or more processing units 124 can be one or more CPUs or GPPs (e.g., GPP-based servers).

The respective processing unit cores (e.g., 116, 118, 120, and/or 122) can comprise a desired number (e.g., two or more) of operational states. In some embodiments, a processing unit core (e.g., 116, 118, 120, or 122) can comprise two operational states, which can include an active (e.g., on, allocated, highest, awake, or otherwise active) state and an inactive (e.g., off, unallocated, lowest, sleep, or otherwise inactive) state. In certain other embodiments, the processing unit core can comprise more than two operational states (e.g., operational states, such as C-states, that can range from C0 to C6), comprising an active state (e.g., C0, on, allocated, highest, awake, or otherwise active state), a lowest inactive state (e.g., C6, off, unallocated, lowest, sleep, or otherwise lowest inactive state), and other inactive states (e.g., C1, C2, C3, C4, and/or C5) that can be lower inactive states that can be higher than the lowest inactive state and lower than the active state. For instance, the C1 state can be the highest inactive state and C6 can be the lowest inactive state. A higher inactive state (e.g., C1 state) typically can be a shallower sleep or inactive state than a relatively lower inactive state (e.g., C6 state). A higher inactive state (e.g., C1 state) also typically can utilize more power than a relatively lower inactive state (e.g., C6 state). Further, a higher inactive state (e.g., C1 state) typically can utilize less time to transition to the active state (e.g., C0 state) than the amount of time it can take for a relatively lower inactive state (e.g., C6 state) to transition to the active state. It is to be appreciated and understood that, while, in some embodiments, a processing unit core can have seven operational states (e.g., C0 through C6), in other embodiments, a processing unit core can have more or less than seven operational states.

As disclosed, the one or more processing units 124 can be one or more CPUs or GPPs (e.g., GPP-based servers), as opposed to the RAN employing existing technology, such as a legacy BBU that can be purpose-built, power efficient hardware that can be used in the public wireless markets. In accordance with various embodiments, the one or more processing units 124, including the group of processing unit cores (e.g., 116, 118, 120, and/or 122), can be associated with (e.g., communicatively, physically, and/or logically connected to) the DU 108, or the DU 108 can comprise the one or more processing units 124.

As disclosed, the wireless industry has some concern regarding vendor lock-in and supply chain risks with regard to legacy BBUs. A CPU (e.g., general CPU) or GPP-based server can be considered as a potential alternative to legacy BBUs to alleviate the vendor lock-in and supply chain risks associated with legacy BBUs. A significant challenge for adoption of a 5G disaggregated RAN hosted on GPP-based server can be to have such 5G disaggregated RAN hosted on a GPP-based server be either at par in energy efficiency or more energy efficient as compared to legacy BBUs. Due to such challenge, while a disaggregated RAN hosted on a GPP-based server can be considered as a potential alternative to legacy BBUs, with existing technology, the use of a GPP-based server to host a disaggregated RAN has not been able to be utilized or to penetrate the markets as expected because of energy consumption concerns associated with using GPP-based servers to host disaggregated RANs. Thus, existing systems and techniques can be deficient in these and other ways.

The disclosed subject matter can overcome these deficiencies and other problems of existing techniques. To that end, in accordance with various embodiments, the system 100 can comprise a processor manager component 126 that desirably (e.g., automatically, dynamically, suitably, reliably, efficiently, enhancedly, and/or optimally) can perform and manage resources, including the group of processing unit cores (e.g., 116, 118, 120, and/or 122), of or associated with the RAN 106, including the DU 108 in connection with performance of baseband processing and other functions and operations of the RAN 106. For instance, the processor manager component 126 can manage (e.g., control) allocation (e.g., granting or reclaiming) of respective processing unit cores (e.g., 116, 118, 120, and/or 122) of the group of processing unit cores and/or manage respective operational states of the respective processing unit cores such that QoS associated with the RAN 106 can be desirably achieved and maintained (e.g., to satisfy the defined threshold minimum perceived QoS level or value), while also mitigating (e.g., reducing or minimizing) energy consumption by the RAN 106 (e.g., by or associated with the DU 108, the group of processing unit cores, and/or other component of the RAN 106), in accordance with the defined processor management criteria, such as described herein.

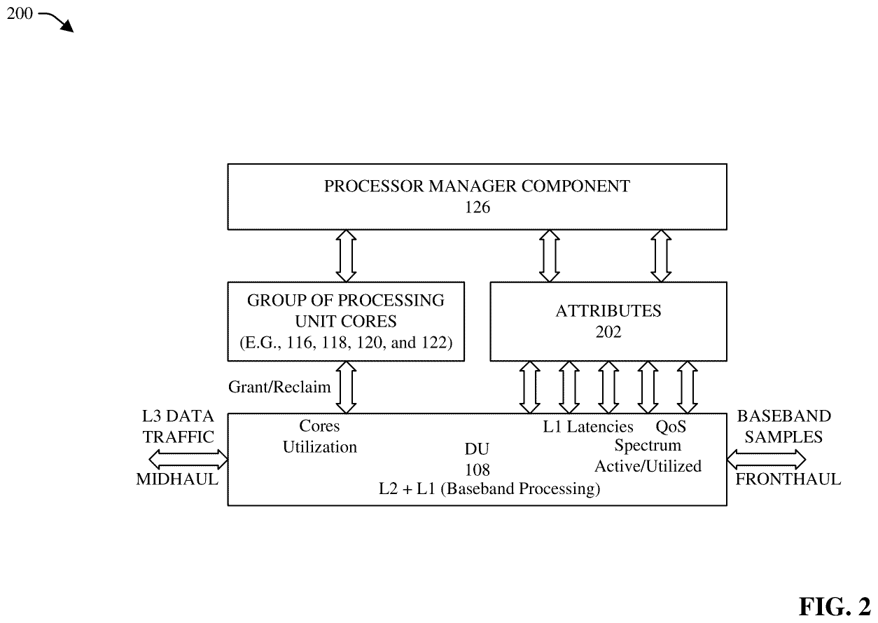

Referring to FIG. 2 (along with FIG. 1), FIG. 2 depicts a block diagram of a non-limiting example process and information flow 200 that can desirably (e.g., automatically, dynamically, suitably, reliably, efficiently, enhancedly, and/or optimally) manage resources, including processing unit cores, associated with a RAN to facilitate satisfying QoS associated with the RAN while also utilizing (e.g., consuming) a desirably lower amount of energy, in accordance with various aspects and embodiments of the disclosed subject matter. In some embodiments, the components presented in connection with the process and information flow 200 can be part of the system 100 as shown in FIG. 1 and described herein.

In accordance with various embodiments, the processor manager component 126 can execute (e.g., periodically, continuously, or dynamically execute) enhanced mechanisms, techniques, methods, processes, and/or algorithms (e.g., enhanced processor management algorithms and other algorithms) to desirably manage resources of the RAN 106, including managing allocation of respective processing unit cores (e.g., 116, 118, 120, and/or 122) of the group of processing unit cores and/or manage respective operational states of the respective processing unit cores, based at least in part on (e.g., as a function of) conditions (e.g., run-time conditions) of a group of attributes 202 associated with the RAN 106, such that the QoS (e.g., perceived QoS) associated with the RAN 106 can be desirably achieved and maintained to satisfy the defined threshold minimum perceived QoS level or value, while also desirably achieving relatively lower (e.g., reduced or minimized) energy consumption by the RAN 106 (e.g., by or associated with the DU 108, the group of processing unit cores, and/or other component of the RAN 106), in accordance with the defined processor management criteria, such as described herein. In some embodiments, the processor manager component 126 can authorize the allocation of the respective processing unit cores (e.g., 116, 118, 120, and/or 122) of the group of processing unit cores (e.g., allocation of isolated CPU cores from a prebuilt pool of available isolated CPU cores) and release of granted (e.g., allocated) processing unit cores to reclaim for the group of processing unit cores (e.g., the cores pool) in order to enhance (e.g., improve or optimize conserving, reducing, or minimizing) energy consumption of the RAN 106 while maintaining the QoS (e.g., perceived QoS) associated with the RAN 106 at or above the applicable threshold QoS (e.g., the defined threshold minimum perceived QoS level or value).

In certain embodiments, the processor manager component 126 can monitor and evaluate (e.g., periodically, continuously, or dynamically monitor and evaluate) conditions of baseband processing of the RAN 106 (e.g., the DU 108 of the RAN 106) and conditions of the attributes 202 associated with the RAN 106. The group of attributes 202 can be significant elements of the mechanism employed by the processor manager component 126 to facilitate enhancing (e.g., conserving, reducing, or minimizing) energy consumption of the RAN 106 while maintaining the QoS at or above the applicable threshold QoS. The group of attributes 202 can comprise or relate to a duplex type (e.g., time division duplex (TDD), frequency division duplex (FDD), or other duplex type assignments) associated with communication of data between the RAN 106 (e.g., DU 108 or base station of the RAN 106) and a device (e.g., device 112 or device 114), an active (e.g., enabled) spectrum associated with the RAN 106, a spectrum utilization associated with the RAN 106, a spectral efficiency associated with the RAN 106, a TTI associated with the RAN 106, a number of the respective processing unit cores (e.g., 116, 118, 120, and/or 122) allocated by the RAN 106, a level of utilization of the respective processing unit cores (e.g., 116, 118, 120, and/or 122), an overall L1 latency (e.g., allowed budget with 1xTTI-4xTTI) associated with the RAN 106, respective operational states (e.g., C-states) of respective unallocated processing unit cores of the group of processing unit cores (e.g., 116, 118, 120, and/or 122), a frequency associated with the group of processing unit cores (e.g., 116, 118, 120, and/or 122), midhaul incoming and outgoing data traffic to and from the RAN 106, a number of devices (e.g., devices 112 and/or 114) being scheduled per the TTI, a QoS (e.g., a perceived QoS) associated with the RAN 106, and/or another attribute associated with the RAN 106.

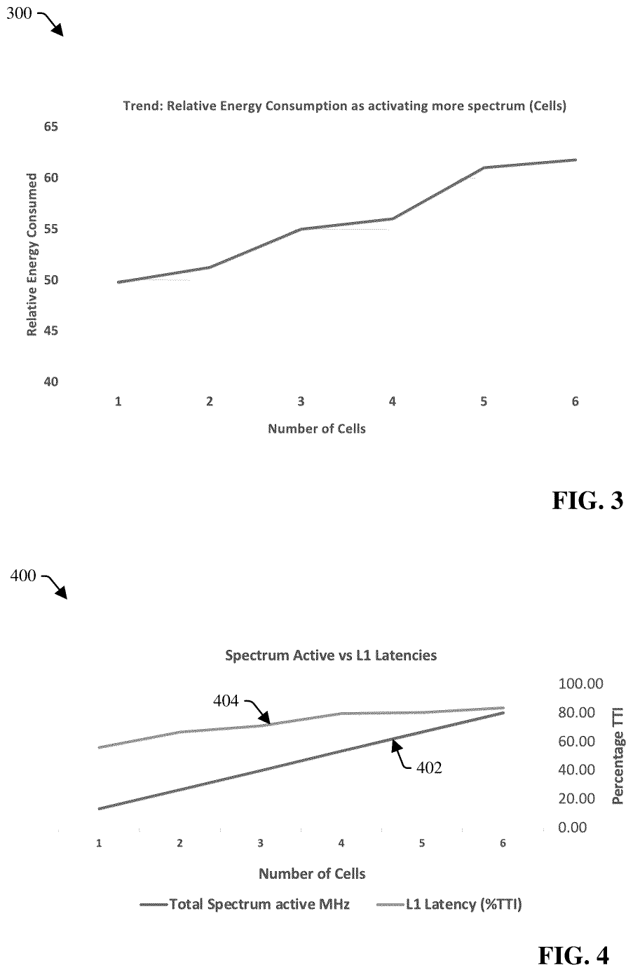

Referring to FIGS. 3-10 (along with FIGS. 1 and 2), FIGS. 3-10 present diagrams of respective graphs that can illustrate certain relationships between certain attributes under different conditions, in accordance with various aspects and embodiments of the disclosed subject matter. As disclosed, the processor manager component 126, and the mechanisms employed by the processor manager component 126, can operate to manage the resources, including the group of processing unit cores (e.g., 116, 118, 120, and/or 122) based at least in part on the analysis of the behavior of respective attributes of the group of attributes 202 and the impact on the overall QoS (e.g., overall perceived QoS) associated with the RAN 106. The processor manager component 126 can desirably fine tune operation of the RAN 106 (e.g., the DU 108 and/or other components of the disaggregated RAN), including management of resources (e.g., the group of processing unit cores and/or other resources), to maintain the QoS desirably high (e.g., maintain the perceived QoS at or above the defined threshold minimum perceived QoS) while desirably (e.g., suitably, efficiently, enhancedly, or optimally) managing the RAN 106 to have relatively lower (e.g., reduced or minimized) energy consumption (e.g., power consumption), in accordance with the defined processor management criteria. FIGS. 3-10 can illustrate respective relationships between respective attributes and associated conditions, the resources (e.g., the group of processing unit cores and/or other resources), energy consumption, and/or other elements of or associated with the RAN 106, to facilitate understanding of various aspects and embodiments of the operations and features of the processor manager component 126, and the enhanced mechanisms, techniques, methods, processes, and/or algorithms disclosed and employed herein, to desirably manage the resources associated with the RAN 106 to maintain a desired QoS while conserving (e.g., reducing or minimizing) energy consumption of the RAN 106. To facilitate understanding, with regard to FIGS. 3-10, the spectrum can be represented by the cells (e.g., multiple input, multiple output (MIMO): 4×4 channel bandwidth: 100 megahertz (MHz)).

FIG. 3 depicts a diagram of an example graph 300 that can illustrate relative energy consumption of the RAN (e.g., RAN 106) as spectrum (e.g., Megahertz [symbol] MIMO layers) and/or cells of the RAN are activated or deactivated, in accordance with various aspects and embodiments of the disclosed subject matter. The graph 300 can show the amount of relative energy consumed by the RAN (y-axis) relative to the number of cells of the RAN activated (x-axis). As can be observed in the graph 300, as the number of cells that are activated increases (and, correspondingly, as the amount of the spectrum associated with the cells and the RAN that is activated increases), the higher the amount of energy consumed by the RAN can be. Conversely, as the number of cells that are activated decreases (and, correspondingly, as the amount of the spectrum associated with the cells and the RAN that is activated decreases), the lower the amount of energy consumed by the RAN can be. Thus, as can be noticeable in the trend presented in the graph 300, the energy consumption of the RAN can be directly impacted by activating or deactivating the cells of the RAN. The processor manager component 126 can be focused on lowering (e.g., reducing or minimizing) the energy consumption of the RAN on activating or deactivating the spectrum (e.g., the amount of spectrum) of the RAN along with (e.g., while still) maintaining the perceived QoS within the desired limits (e.g., maintaining the perceived QoS such that it satisfies (e.g., meets or exceeds) the defined threshold minimum perceived QoS).

FIG. 4 presents a diagram of an example graph 400 that can illustrate the spectrum (e.g., spectrum of the RAN) enabled versus L1 latencies of the RAN (e.g., RAN 106), in accordance with various aspects and embodiments of the disclosed subject matter. The graph 400 can indicate the number of cells of the RAN activated (x-axis) in relation to the percentage TTI (y-axis). The graph 400 can present data points of the total spectrum active 402 (in MHz) for the RAN relative to the number of cells active for the RAN and the percentage TTI. The graph 400 also can present data points of the L1 latency 404 (as percentage TTI) for the RAN relative to the number of cells active for the RAN. Based on the analysis of how L1 latency can be impacted (e.g., can be primarily impacted), the L1 latencies can be significantly dependent on activation of more cells of the RAN during peak or normal operation hours or deactivation of some cells of the RAN during off-peak operation hours or less load. In order to desirably maintain the L1 latencies within certain limits (e.g., threshold low or minimum L1 latency and threshold high or maximum L1 latency), it can be desirable (e.g., wanted, required, or otherwise desirable) either to grant or reclaim computing resources (e.g., processing unit cores and/or other resources). The processor manager component 126 can desirably manage the resources of the RAN, including allocation, and/or respective operational states, of the respective processing unit cores (e.g., granting or reclaiming processing unit cores) to desirably maintain L1 latencies of the RAN within the desired limits (e.g., threshold low or minimum L1 latency and threshold high or maximum L1 latency) such that the baseband processing of the RAN does not starve (e.g., the RAN has sufficient computing resources to enable the RAN to desirably perform baseband processing) and does not underutilize computing resources allocated or activated for the RAN (e.g., the RAN does not have an undesirable or significant amount of allocated or activated computing resources that are not being utilized or are otherwise underutilized).

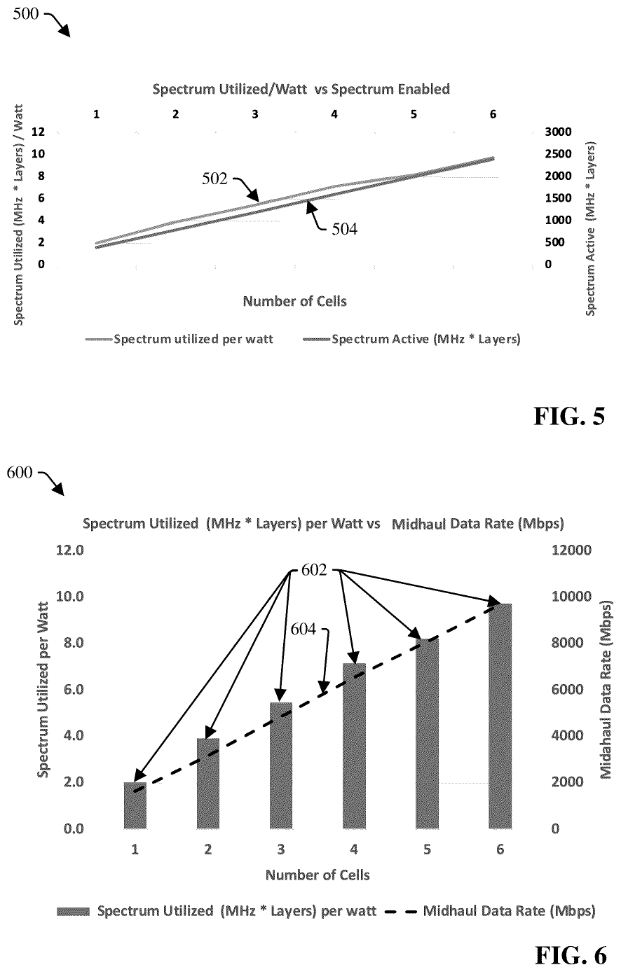

FIG. 5 depicts a diagram of an example graph 500 that can illustrate spectrum utilized (in (MHz [symbol] MIMO layers)/watt) by the RAN (e.g., RAN 106) versus spectrum (in MHz [symbol] MIMO layers) enabled (e.g., activated) on the RAN, in accordance with various aspects and embodiments of the disclosed subject matter. The graph 500 can indicate the number of cells of the RAN activated (x-axis) in relation to the spectrum utilized per watt (y-axis (left side)) and in relation to the spectrum activated (y-axis (right side)). The graph 500 can present data points of the spectrum utilized per watt 502 (in (MHz [symbol] MIMO layers)/watt) for the RAN relative to the number of cells active for the RAN. The graph 500 also can present data points of the spectrum activated 504 (in MHz [symbol] MIMO layers) for the RAN relative to the number of cells active for the RAN. The spectrum utilized per watt can depend on the active spectrum of the RAN. The spectrum utilized per watt by the RAN can be one of the significant factors that can be determined, by the processor manager component 126, to determine how the RAN platform and RAN stack is performing for the existing workload of the RAN, to facilitate desirably managing resources of the RAN to reduce or minimize power consumption by the RAN while maintaining the desired QoS associated with the RAN. The processor manager component 126 can desirably determine a lower (e.g., enhancedly or optimally reduced, minimized, or lowest) the energy consumption by spectrum utilized as cells of the RAN are activated and deactivated (and, correspondingly, resources, such as the respective processing unit cores are activated or deactivated, and/or have their respective operational states modified to higher or lower operational states). As can be observed by the spectrum utilized per watt 502 and the spectrum activated 504 in the graph 500, the spectrum utilized per watt 502 and the spectrum activated 504 can be substantially linear, and the spectrum utilized per watt 502 can increase as the number of cells activated increases, and can decrease as the number of cells activated decreases, in a substantially linear manner.

FIG. 6 presents a diagram of an example graph 600 that can illustrate spectrum utilized (in (MHz [symbol] MIMO layers)/watt) by the RAN (e.g., RAN 106) versus a midhaul data rate (in megabytes per second (Mbps)) of the RAN, in accordance with various aspects and embodiments of the disclosed subject matter. The graph 600 can indicate the number of cells of the RAN activated (x-axis) in relation to the spectrum utilized per watt (y-axis (left side)) and in relation to the midhaul data rate (y-axis (right side)) to illustrate the spectrum utilized per watt versus (e.g., in relation to) the midhaul data rate (e.g., downlink user data traffic on midhaul associated with the RAN). The graph 600 can present data points of the spectrum utilized per watt 602 (in (MHz [symbol] MIMO layers)/watt) for the RAN relative to the number of cells active for the RAN. The graph 600 also can present data points of the midhaul data rate 604 (in Mbps) for the RAN relative to the number of cells active for the RAN. As can be observed in the graph 600, as the number of activated cells increases, the spectrum utilized per watt 602 and the midhaul data rate 604 can increase in a substantially linear manner. As also can be observed in the graph 600, there can be a relatively close relation between the amount of the spectrum being utilized and the L3 layer data traffic on midhaul, and the amount of energy consumed by the RAN (e.g., as the amount of the spectrum and the midhaul data traffic increases, the amount of energy consumed by the RAN can increase). The processor manager component 126 can focus on this relatively close relation between the spectrum utilized per watt 602, the midhaul data rate 604, and the amount of energy consumed by the RAN, and such close relation can be a significant factor to enhance (e.g., improve or optimize) management of energy consumption by the RAN (e.g., by reducing or minimizing RAN energy consumption while satisfying the desired QoS associated with the RAN).

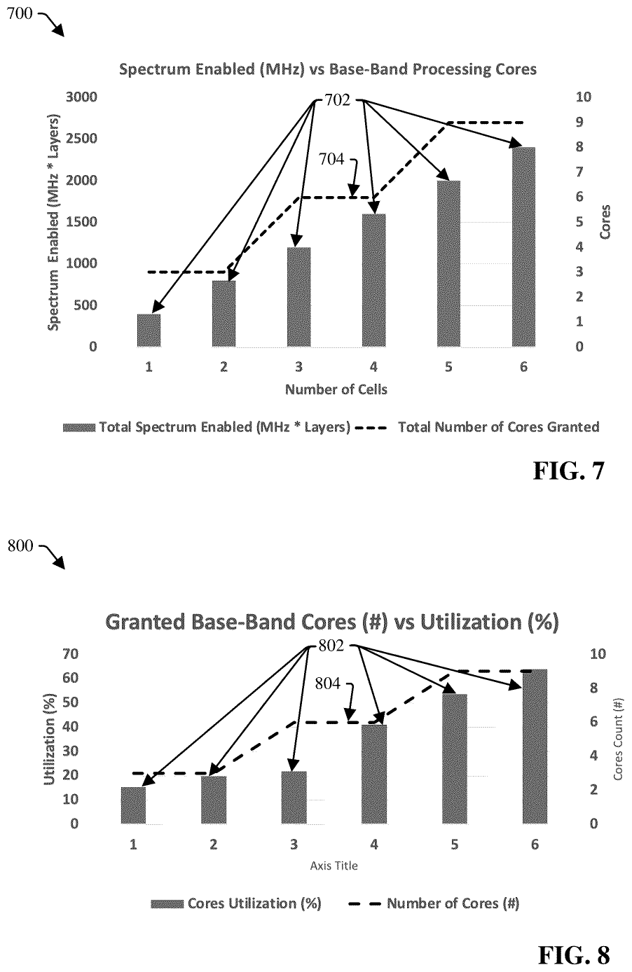

FIG. 7 depicts a diagram of an example graph 700 that can illustrate total spectrum activated (in (MHz [symbol] MIMO layers)) by the RAN (e.g., RAN 106) versus total number of processing unit cores granted (e.g., allocated or activated) by the RAN, in accordance with various aspects and embodiments of the disclosed subject matter. The graph 700 can indicate the number of cells of the RAN activated (x-axis) in relation to the spectrum activated (y-axis (left side)) and in relation to the total number of processing unit cores (e.g., baseband processing cores) granted (y-axis (right side)) to illustrate the spectrum activated versus (e.g., in relation to) the total number of processing unit cores granted. The graph 700 can present the amount of spectrum activated 702 (in (MHz [symbol] MIMO layers)) for the RAN relative to the number of cells active for the RAN. The graph 700 also can present data points of the total number of processing unit cores granted 704 for the RAN relative to the number of cells active for the RAN. As can be observed in the graph 700, there can be a relatively close relation how the number of processing unit cores are being utilized to activate the desired (e.g., wanted or required) spectrum (e.g., desired spectrum to achieve and maintain the desired QoS). The processor manager component 126 can focus on this relatively close relation between the total number of processing unit cores granted 704 and the amount of spectrum activated 702. This knowledge of and focus on the relation between the total number of processing unit cores granted 704 and the amount of spectrum activated 702 by the processor manager component 126 can enable the processor manager component 126 to dynamically manage granting or reclaiming the processing unit cores and/or modifications of operational states of the processing unit cores depending in part on the time of day, the load on the RAN (e.g., the DU of the RAN), the desired QoS (e.g., QoS that can satisfy the defined threshold minimum QoS), events associated with the RAN, and/or other factors or attributes associated with the RAN, which can enable the processor manager component 126 to enhance management of energy consumption by the RAN, including during frequently or continuously changing conditions associated with the RAN and/or devices associated therewith (e.g., by reducing or minimizing RAN energy consumption while satisfying the desired QoS).

FIG. 8 depicts a diagram of an example graph 800 that can illustrate processing unit core utilization (as a percentage) by the RAN (e.g., RAN 106) versus the number of processing unit cores granted for the RAN. in accordance with various aspects and embodiments of the disclosed subject matter. The graph 800 can indicate the number of cells of the RAN activated (x-axis) in relation to the utilization of the granted processing unit cores (y-axis (left side)) and in relation to the number of processing unit cores granted (y-axis (right side)). The graph 800 can present data points of the processing unit core utilization 802 (as a percentage) of the RAN relative to the number of cells active for the RAN. The graph 800 also can present data points of the number of processing unit cores granted 804 for the RAN relative to the number of cells active for the RAN. The utilization of currently granted processing unit cores (e.g., baseband processing unit cores) can have a direct impact on the QoS associated with the RAN. The processor manager component 126, employing the processes, methods, techniques, and algorithms disclosed herein, can ensure that the processing unit cores of the group of processing unit cores (e.g., 116, 118, 120, and/or 122) are not being underutilized or overutilized. The processor manager component 126 can maintain a desirably fine balance on allocated processing unit cores depending in part on frequently or continuous changing conditions of load, desired QoS, and/or other attributes associated with the RAN, which can enable the processor manager component 126 to desirably enhance management of energy consumption by the RAN (e.g., desirably reduce or minimize energy consumption by the RAN while satisfying the desired QoS associated with the RAN).

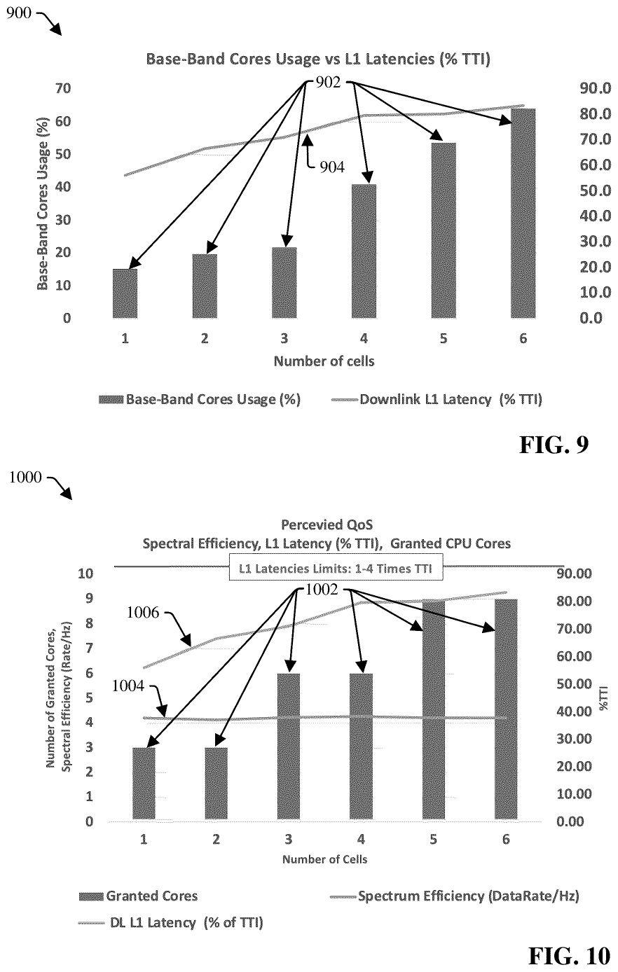

FIG. 9 presents a diagram of an example graph 900 that can illustrate processing unit core utilization (as a percentage) by the RAN (e.g., RAN 106) versus L1 layer latencies associated with the RAN, in accordance with various aspects and embodiments of the disclosed subject matter. The graph 900 can indicate the number of cells of the RAN activated (x-axis) in relation to the utilization of the granted processing unit cores (y-axis (left side)) and in relation to the Layer 1 latencies associated with the RAN (y-axis (right side)). The graph 900 can present data points of the processing unit core utilization (e.g., utilization of allocated processing unit cores) 902 (as a percentage) of the RAN relative to the number of cells active for the RAN. The graph 900 also can present data points of the L1 layer latencies 904 associated with the RAN relative to the number of cells active for the RAN. As can be observed in the graph 900, the L1 layer latencies 904 can be significantly impacted by the utilization of the allocated processing unit cores 902. The processor manager component 126, employing the processes, methods, techniques, and algorithms disclosed herein, can ensure that the processing unit cores of the group of processing unit cores (e.g., 116, 118, 120, and/or 122) are not being underutilized or overutilized to keep the L1 layer latencies as low as possible to maintain or boost the QoS such that the QoS can satisfy the defined threshold QoS, while at the same time desirably enhancing management of energy consumption by the RAN to desirably reduce or minimize energy consumption by the RAN by desirably managing the number of processing unit cores allocated and/or desirably managing the respective operational states of the respective processing unit cores for the RAN.

FIG. 10 illustrates a diagram of an example graph 1000 of perceived normalized QoS associated with the RAN (e.g., RAN 106) versus granted processing unit cores of the RAN, in accordance with various aspects and embodiments of the disclosed subject matter. The graph 1000 can indicate the number of cells of the RAN activated (x-axis) in relation to the number of granted processing unit cores and spectral efficiency (in rate/hertz (Hz)) (y-axis (left side)) and in relation to percentage of TTI associated with the RAN (y-axis (right side)). The graph 1000 can present data points of the number of granted processing unit cores 1002 of the RAN relative to the number of cells active for the RAN. The graph 1000 also can present data points of the spectral efficiency 1004 associated with the RAN relative to the number of cells active for the RAN. The graph 1000 further can present data points of the percentage of TTI 1006 (e.g., downlink L1 layer latency) associated with the RAN relative to the number of cells active for the RAN. Significant measures for normalized QoS (e.g., determined or calculated based at least in part on perceived throughput downlink and uplink per spectrum (MHz [symbol] MIMO layers) multiplied by granted processing unit core utilization) can be performance, overheads, and processing unit cores utilization of or associated with the RAN. The processor manager component 126, employing the processes, methods, techniques, and algorithms disclosed herein, can ensure that the overheads associated with the RAN can be desirably lower (e.g., reduced or minimized) while maintaining performance of the RAN at a desirably high level with expectable resources of the RAN, including processing unit cores, being desirably (e.g., suitably or optimally) utilized.

In some embodiments, the processor manager component 126 can determine the perceived QoS associated with the RAN 106 as a function of spectrum efficiency, L1 layer latencies, utilization of the processing unit cores associated with the RAN 106, and/or other factors. In certain embodiments, the processor manager component 126 can determine (e.g., calculate) the perceived QoS associated with the RAN 106 as a function of total throughput (downlink and uplink), spectrum activated (e.g., enabled), utilization of processing unit cores, L1 layer latency, the number of processing unit cores allocated, and/or other factors. In some embodiments, the processor manager component 126 can determine (e.g., calculate) the perceived QoS as perceived QoS=function of [spectral-efficiency, utilization-per-processing-unit-core, L1-latency], wherein spectral-efficiency (within specified range)=total throughput (downlink and uplink) (in Mbps)/spectrum enabled (MHz [symbol] MIMO layers), wherein utilization-per-processing-unit-core (within specified range)=allocated processing unit cores utilization (percent)/number of processing unit cores allocated, wherein L1-latency (less than N [symbol] TTI with specified N=1, 2, 3, 4, or other number greater than 4)=L1-latency (non-percent) [symbol] transmission time interval (TTI) (in microseconds), and wherein non-percent can mean the numerical value of a percentage divided by 100 (e.g., the non-percent value of 20% can be 20/100, and the non-percent value of 40% can be 40/100). TTI can be, for example, the amount of transmission time of multiple consecutive orthogonal frequency division multiplexing (OFDM) symbols on the air for a specific numerology that a medium access control (MAC) scheduler has to schedule ahead. The changes in these three values (e.g., spectral-efficiency, utilization-per-processing-unit-core, L1-latency) of the “perceived QoS” can infer (e.g., can be utilized by the processor manager component 126 to infer or determine) the trend of over or under utilization of allocated processing unit cores.

In certain embodiments, the processor manager component 126 can recognize the direct impact of the channel conditions associated with the RAN 106 on the perceived MIMO layers, baseband processing, hybrid automatic repeat request (HARQ), utilizations of processing unit cores (e.g., 116, 118, 120, and/or 122), and the overall midhaul data rates associated with the RAN 106. The impact of the channel conditions associated with the RAN 106 on these attributes can have a direct impact on the perceived QoS and the management of the energy consumption of the RAN 106 by the processor manager component 126.

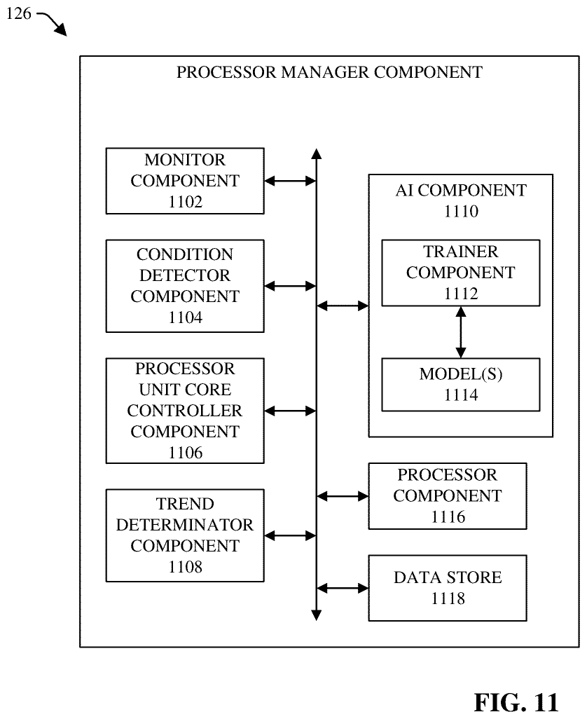

Referring to FIG. 11 (along with FIGS. 1 and 2), FIG. 11 depicts a block diagram of the processor manager component 126, in accordance with various aspects and embodiments of the disclosed subject matter. In accordance with various embodiments, the processor manager component 126 can comprise a monitor component 1102, a condition detector component 1104, a processor unit core controller component 1106, a trend determinator component 1108, and/or an AI component 1110. In some embodiments, the AI component 1110 can comprise a trainer component 1112 and one or more models 1114 (e.g., AI-based models). In certain embodiments, the processor manager component 126 can comprise a processor component 1116 and a data store 1118.

In accordance with various embodiments, the processor manager component 126, employing the monitor component 1102, can monitor (e.g., periodically, continuously, or dynamically monitor) the conditions of attributes (e.g., 202) associated with the RAN 106 (e.g., disaggregated RAN comprising the DU 108), the group of processing unit cores (e.g., 116, 118, 120, and/or 122), the devices (e.g., 112 and/or 114), and/or the core network 104. In some embodiments, the processor manager component 126 can transition to an active mode (e.g., from an inactive or sleep mode) to monitor the conditions of the attributes periodically (e.g., after a defined period of time has elapsed) and/or dynamically in response to detecting an event (e.g., a monitoring or evaluation triggering event) associated with the RAN 106. After the processor manager component 126 has performed its various operations, including monitoring, analysis (e.g., evaluation), and/or managing or modifying allocation of processing unit cores and/or respective operational states of respective processing unit cores, the processor manager component 126 can transition to the inactive state for the defined period of time or until an event (if any) is detected. In other embodiments, the processor manager component 126 can continuously or substantially continuously monitor the conditions of the attributes and/or perform other operations. Based at least in part on the monitoring, the processor manager component 126 can receive respective items of attribute information relating to the group of attributes 202 relating to conditions associated with the RAN 106 from the RAN 106, the group of processing unit cores (e.g., 116, 118, 120, and/or 122), the devices (e.g., 112 and/or 114) associated with the RAN 106, sensors of or associated with the RAN 106, and/or the core network 104.

In some embodiments, the condition detector component 1104 can analyze (e.g., evaluate) the respective items of attribute information and/or other information associated with the RAN 106. Based at least in part on the results of such analysis, the condition detector component 1104 can determine or detect respective conditions of the respective attributes of the group of attributes 202. For example, based at least in part on the results of such analysis, the condition detector component 1104 can determine the duplex type associated with communication of data between the RAN 106 and a device (e.g., 112 or 114), the active spectrum associated with the RAN 106, the spectrum utilization associated with the RAN 106, the spectral efficiency associated with the RAN 106, the TTI associated with the RAN 106, the number of the respective processing unit cores (e.g., 116, 118, 120, and/or 122) allocated by the RAN 106, the level of utilization of the respective processing unit cores, the overall L1 latency associated with the RAN 106, the respective operational states of respective unallocated processing unit cores, the frequency associated with the group of processing unit cores, the midhaul incoming and outgoing data traffic to and from the RAN 106, the number of devices being scheduled per the TTI, the QoS (e.g., a perceived QoS) associated with the RAN 106, and/or another attribute associated with the RAN 106.

Based at least in part on the respective conditions of the respective attributes of the group of attributes 202, the processor unit core controller component 1106 can control resources, including allocation and/or respective operational states of respective processing unit cores of the group of processing unit cores (e.g., 116, 118, 120, and/or 122), of the RAN 106 such that the QoS (e.g., perceived QoS value or level) associated with the RAN 106 can satisfy (e.g., can meet or exceed; or can be at or greater than) the defined threshold QoS (e.g., the defined threshold minimum QoS value or level) while desirably conserving (e.g., reducing or minimizing) the energy consumption of the RAN 106, in accordance with the defined processor management criteria. In accordance with various embodiments, in addition to and/or as an alternative to controlling the resources of the RAN 106 depending in part on the current condition(s) of the attribute(s) associated with the RAN 106, the processor unit core controller component 1106 can manage the allocation and/or respective operational states of respective processing unit cores of the group of processing unit cores (e.g., 116, 118, 120, and/or 122) based at least in part on a trend(s) of a condition(s) of the attribute(s) (e.g., one or more trends of one or more conditions of one or more attributes) and/or a predicted condition(s) of the attribute(s) at a future time (e.g., one or more predicted conditions of one or more attributes) associated with the RAN 106, in accordance with the defined processor management criteria.

In some embodiments, the trend determinator component 1108 can determine a trend(s) in the condition(s) of an attribute(s) based at least in part on the respective conditions of the respective attributes and respective previous conditions of the respective attributes. For instance, previous condition information relating to the respective previous conditions of the respective attributes can be stored in the data store 1118. The trend determinator component 1108 (or another component) can retrieve the previous condition information from the data store 1118. The trend determinator component 1108 can compare the condition information (e.g., current condition information) relating to the respective conditions of the respective attributes to the previous condition information. Based at least in part on the results of such comparison, the trend determinator component 1108 can determine the trend(s) in the condition(s) of the attribute(s).

In certain embodiments, the AI component 1110 (e.g., employing a trained AI-based model 1114) can perform an AI-based analysis on the condition information, the previous condition information, and/or other information relating to the RAN 106. Based at least in part on the results of the AI-based analysis, the AI component 1110 (e.g., employing a trained AI-based model 1114) can predict the condition(s) of an attribute(s) (e.g., predicted condition(s)) of the attribute(s) at a defined time in the future (e.g., at a defined amount of time in the future from the current time of the condition(s)).

In some instances, the RAN 106 may be located near a venue or location that can have a higher number of devices and/or a higher amount of data traffic at certain times (e.g., certain time(s) of day, certain days of the week, or certain dates). For example, the RAN 106 may be located in proximity to a venue (e.g., within the coverage area of the RAN 106) that can have events (e.g., sporting events, concerts, shows, or other events) where a large number of people with devices can gather on certain dates of the events, the RAN 106 may be located in proximity to a number of business buildings (e.g., located within the coverage area of the RAN 106) where a large number of workers and/or customers with devices during certain times of the day (e.g., 8:00 a.m. to 5:00 p.m., or other time(s) of day) and days of the week (e.g., Monday through Friday), or the RAN 106 can be located in proximity to a busy highway or road (e.g., located within the coverage area of the RAN 106) where a large amount of vehicle traffic, with users and devices, can be traveling during certain times of the day (e.g., 7:00 a.m. to 9:00 a.m., 4:00 p.m. to 6:00 p.m., or other time(s) of day) and days of the week (e.g., Monday through Friday). The processor manager component 126 (e.g., the trend determinator component 1108 and/or the AI component 1110 (e.g., employing a trained AI-based model 1114)) can have (e.g., can receive or obtain) and analyze information relating to the venue(s) or location(s), the event(s), the business building(s), the busy highway(s) or road(s), and/or the certain time(s) of day, certain days of the week, or certain dates where data traffic associated with devices can be higher and other times where data traffic associated with devices can be relatively lower. Based at least in part on the results of the analysis of such information and other information relating to attributes associated with the RAN 106, the processor manager component 126 (e.g., the trend determinator component 1108 and/or the AI component 1110 (e.g., employing a trained AI-based model 1114)) can determine a trend(s) in a condition(s) of an attribute(s) and/or can predict a condition(s) of an attribute(s) at a future time.

Based at least in part on the condition(s), the trend(s) in the condition(s), and/or the predicted condition(s) of the attribute(s), the processor manager component 126 can manage allocation of the respective processing unit cores of the group of processing unit cores (e.g., 116, 118, 120, and/or 122), including determining whether to allocate (e.g., grant), unallocate (e.g., reclaim), or maintain (e.g., maintain at the same number of) the respective processing unit cores of the group of processing unit cores, and/or can manage the respective operational states of the respective processing unit cores, including determining whether to modify (e.g., adjust, increase or raise, or decrease or lower), the respective operational states of the respective processing unit cores, in accordance with the defined processor management criteria. In some embodiments, to facilitate determining whether a modification is to be made to the number of processing unit cores allocated (e.g., activated) for the RAN 106, and/or the respective operational states of the respective processing unit cores, the processor manager component 126 (e.g., employing the processor unit core controller component 1106) can determine whether the condition(s) (e.g., condition value(s)) satisfies a defined threshold condition value relating to (e.g., applicable to) the condition(s), whether the trend of the condition(s) (e.g., trend of the condition value(s)) satisfies a defined threshold condition trend value relating to the condition(s), and/or whether the predicted condition(s) (e.g., predicted condition value(s)) satisfies a defined threshold predicted condition value relating to the condition(s). In certain embodiments, the processor unit core controller component 1106 can determine whether an amount of change of the condition satisfies a defined threshold (e.g., threshold minimum; or, conversely, threshold maximum) amount of change of the condition that, when satisfied, can indicate that there is trend of change in the condition sufficient to indicate that modification of the allocation and/or respective operational states of the respective processing unit cores can be desired (e.g., wanted, needed, useful, beneficial, or otherwise desired). Additionally or alternatively, the processor unit core controller component 1106 can determine whether an amount of change or difference between the predicted condition and the condition (e.g., current condition) satisfies a defined threshold (e.g., threshold minimum; or, conversely, threshold maximum) amount of change or difference between the predicted condition and the condition that, when satisfied, can indicate that the predicted change in the condition can be sufficient to indicate that modification of the allocation and/or respective operational states of the respective processing unit cores can be desired.

If the processor unit core controller component 1106 determines that no applicable threshold condition value (e.g., the defined threshold condition value, defined threshold condition trend value, defined threshold predicted condition value, defined threshold amount of change of the condition, and/or defined threshold amount of change or difference between the predicted condition and the condition) is satisfied, the processor unit core controller component 1106 can determine that no modification is to be made to the number of processing unit cores allocated for the RAN 106 (e.g., the DU 108 and/or other component of the RAN 106) or the respective operational states of the respective processing unit cores of the group of processing unit cores (e.g., 116, 118, 120, and/or 122), in accordance with the defined processor management criteria.

If, instead, the processor unit core controller component 1106 determines that one or more applicable threshold condition values (e.g., the defined threshold condition value, defined threshold condition trend value, defined threshold predicted condition value, defined threshold amount of change of the condition, and/or defined threshold amount of change or difference between the predicted condition and the condition) are satisfied and indicate that the allocation of the number of processing unit cores allocated for the RAN 106 is to be increased and/or the respective operational states of the respective processing unit cores of the group of processing unit cores (e.g., 116, 118, 120, and/or 122) are to be increased (e.g., raised), the processor unit core controller component 1106 can determine that a modification to the allocation and/or respective operational states of the respective processing unit cores can be performed, and can determine the modification to the allocation and/or respective operational states of the respective processing unit cores that can be performed, based at least in part on the condition(s), the trend in condition(s), the predicted condition(s), and/or the applicable threshold condition value(s), in accordance with the defined processor management criteria.

For example, if the applicable threshold condition value(s) is determined to be satisfied, and the condition(s), the trend in condition(s), and/or the predicted condition(s) indicates that an increase in the allocation of the number of processing unit cores allocated for the RAN 106 and/or the respective operational states of the respective processing unit cores (e.g., 116, 118, 120, and/or 122) can be desired (e.g., wanted, needed, useful, beneficial, or otherwise desired) to enable the QoS (e.g., perceived QoS) associated with the RAN 106 to satisfy the defined threshold QoS (e.g., the defined threshold minimum perceived QoS), the processor unit core controller component 1106 can determine the increase in the allocation of the number (e.g., the increased number) of processing unit cores allocated for the RAN 106 and/or the increase (e.g., raise) in the respective operational states of the respective processing unit cores (e.g., 116, 118, 120, and/or 122) that can enable the QoS associated with the RAN 106 to satisfy the defined threshold QoS while also enabling the RAN 106 to consume a desirably lower (e.g., reduced, lowest, or minimum) amount of energy in order to satisfy the defined threshold QoS, in accordance with the defined processor management criteria.

If, for example, the analysis of the condition(s), the trend in condition(s), and/or the predicted condition(s) indicates that the QoS (e.g., perceived QoS) can be significantly and negatively impacted (e.g., can decrease to significantly below the desired threshold minimum perceived QoS level) with the current number of processing unit cores allocated, the processor unit core controller component 1106 can determine that the increase in the allocation of the number (e.g., the increased number) of processing unit cores allocated for the RAN 106 and/or the increase (e.g., raise) in the respective operational states of the respective processing unit cores (e.g., 116, 118, 120, and/or 122) can be relatively more significant (e.g., can significantly increase the number (e.g., by 3 or another suitable, enhanced, or optimal number less or greater than 3) of processing unit cores allocated (e.g., activated) for the RAN 106 and/or can transition a desired number of other processing unit cores from a lower inactive operational state (e.g., transition such other processing unit cores from C6, C5, C4, C3) to a relatively higher inactive operational state (e.g., C1, which can be just below the active state of C0; or C2)) in order to maintain the QoS associated with the RAN 106 so that it can satisfy the defined threshold QoS. Such increase in the number of the processing unit cores allocated and/or the respective operational states of the respective processing unit cores also can be determined by the processor unit core controller component 1106 to consume a desirably lower (e.g., reduced, lowest, or minimal) amount of energy than other increased numbers of processing unit core allocations and/or other increases in respective operational states of respective processing unit cores that can enable the QoS associated with the RAN 106 to satisfy the defined threshold QoS.

As another example, if, instead, the analysis of the condition(s), the trend in condition(s), and/or the predicted condition(s) indicates that the QoS (e.g., perceived QoS) can be negatively impacted (e.g., can decrease to below the desired threshold minimum perceived QoS level, but not as significantly as in the previous example scenario) with the current number of processing unit cores allocated, the processor unit core controller component 1106 can determine that the increase in the allocation of the number (e.g., the increased number) of processing unit cores allocated for the RAN 106 and/or the increase (e.g., raise) in the respective operational states of the respective processing unit cores (e.g., 116, 118, 120, and/or 122) can be relatively less significant (e.g., can increase the number (e.g., by 1 or another suitable, enhanced, or optimal number) of processing unit cores allocated for the RAN 106 and/or can transition a desired number of other processing unit cores from a lower inactive operational state (e.g., transition such other processing unit cores from C6, C5, C4, C3) to a relatively higher inactive operational state (e.g., C1, which can be just below the active state of C0; or C2), wherein the desired number of other processing unit cores may be a smaller number than in the previous example scenario and/or the amount of transition of operational states may be less than in the previous example scenario). Such increase (e.g., relatively smaller increase, as compared to the previous example scenario) in the number of the processing unit cores allocated and/or the respective operational states of the respective processing unit cores also can be determined by the processor unit core controller component 1106 to consume a desirably lower (e.g., reduced, lowest, or minimal) amount of energy than other increased numbers of processing unit core allocations and/or other increases in respective operational states of respective processing unit cores that can enable the QoS associated with the RAN 106 to satisfy the defined threshold QoS.

As still another example, if the applicable threshold condition value(s) is determined to be satisfied, and the condition(s), the trend in condition(s), and/or the predicted condition(s) indicates that a decrease in the allocation of the number of processing unit cores allocated for the RAN 106 and/or a decrease (e.g., lowering of) the respective operational states of the respective processing unit cores (e.g., 116, 118, 120, and/or 122) can be performed and desired (e.g., wanted, needed, useful, beneficial, or otherwise desired) to enable the RAN 106 to reduce the amount of energy consumed (e.g., for baseband processing and/or other functions) to a desirably lower level (e.g., reduced, lowest, or minimal level) while still maintaining a desirable QoS that can satisfy the defined threshold QoS, the processor unit core controller component 1106 can determine the decrease in the allocation of the number (e.g., the decreased number) of processing unit cores allocated for the RAN 106 and/or the decrease (e.g., lowering) in the respective operational states of the respective processing unit cores (e.g., 116, 118, 120, and/or 122) that can enable the RAN 106 to reduce the amount of energy consumed to the desirably lower level while still maintaining the desirable QoS that can satisfy the defined threshold QoS, in accordance with the defined processor management criteria.

In an example scenario, if the analysis of the condition(s), the trend in condition(s), and/or the predicted condition(s) indicates that the number of processing unit cores (e.g., 116, 118, 120, and/or 122) allocated (e.g., activated) for the RAN 106 can be significantly reduced, to desirably reduce the amount of energy consumed by the RAN 106 (e.g., for baseband processing and/or other functions), while enabling the RAN 106 to still maintain a desirable QoS that can satisfy the defined threshold QoS, the processor unit core controller component 1106 can determine that the decrease in the allocation of the number (e.g., the decreased number) of processing unit cores allocated for the RAN 106 and/or the decrease (e.g., lowering) in the respective operational states of the respective processing unit cores can be relatively more significant (e.g., can significantly decrease the number (e.g., by 3 or another suitable, enhanced, or optimal number less or greater than 3) of processing unit cores allocated for the RAN 106 and/or can transition a desired number of other processing unit cores from a higher inactive operational state (e.g., transition such other processing unit cores from C1 or C2) to a relatively lower inactive operational state (e.g., C6, C5, C4, or C3) to enable the RAN 106 to consume a desirably lower (e.g., reduced, lowest, or minimal) amount of energy while maintaining the QoS associated with the RAN 106 such that it can still satisfy the defined threshold QoS. Such decrease in the number of the processing unit cores allocated and/or the respective operational states of the respective processing unit cores can be determined by the processor unit core controller component 1106 to consume a desirably lower (e.g., reduced, lowest, or minimal) amount of energy as compared to other decreased numbers of processing unit core allocations and/or other decreases in respective operational states of respective processing unit cores that can reduce energy consumption by the RAN 106 while enabling the QoS associated with the RAN 106 to satisfy the defined threshold QoS.

In yet another example scenario, if, instead, the analysis of the condition(s), the trend in condition(s), and/or the predicted condition(s) indicates that the number of processing unit cores (e.g., 116, 118, 120, and/or 122) allocated for the RAN 106 can be reduced (e.g., but not as significantly as in the previous example scenario relating to decreasing processing unit core allocation), to desirably reduce the amount of energy consumed by the RAN 106, while enabling the RAN 106 to still maintain a desirable QoS that can satisfy the defined threshold QoS, the processor unit core controller component 1106 can determine that the decrease in the allocation of the number (e.g., the decreased number) of processing unit cores allocated for the RAN 106 and/or the decrease in the respective operational states of the respective processing unit cores can be relatively less significant (as compared to the previous example scenario relating to decreasing processing unit core allocation) (e.g., the processor unit core controller component 1106 can decrease the number (e.g., by 1 or another suitable, enhanced, or optimal number) of processing unit cores allocated for the RAN 106 and/or can transition a desired number of other processing unit cores from a higher inactive operational state (e.g., transition such other processing unit cores from C0 or C1) to a relatively lower inactive operational state (e.g., C6, C5, C4, or C3), wherein the desired number of other processing unit cores may be a smaller number than in the previous example scenario and/or the amount of transition of operational states may be less than in the previous example scenario). Such decrease (e.g., relatively smaller decrease, as compared to the previous example scenario) in the number of the processing unit cores allocated and/or the respective operational states of the respective processing unit cores can be determined by the processor unit core controller component 1106 to consume a desirably lower (e.g., reduced, lowest, or minimal) amount of energy than other decreased numbers of processing unit core allocations and/or other decreases in respective operational states of respective processing unit cores that can enable the QoS associated with the RAN 106 to satisfy the defined threshold QoS.

With further regard to the processor component 1116 and the data store 1118, the processor component 1116 can be associated with (e.g., communicatively connected to) and can work in conjunction with other components of the processor manager component 126, including the monitor component 1102, condition detector component 1104, processor unit core controller component 1106, trend determinator component 1108, AI component 1110, data store 1118, and/or other components of the processor manager component 126, to facilitate performing the various functions and operations of the processor manager component 126. The processor component 1116 can employ one or more processors (e.g., one or more central processing units (CPUs)), accelerators, graphics processing units (GPUs), application-specific integrated circuits (ASICs), microprocessors, or controllers that can process information relating to data, files, services, applications, RANs, cells, communication network, core network, devices, users, resources, processing unit cores, baseband processing, QoS, attributes, conditions, duplex type, active spectrum, spectrum utilization, spectrum efficiency, TTI, processing unit core allocation, processing unit core utilization, latency, operational states of processing unit cores, data traffic, frequencies of processing unit cores, devices scheduled per TTI, communication sessions (e.g., PDU or other communication sessions), AI/ML-based models, AI-related data, training data, feedback information, measurement reports, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined processor management criteria, algorithms (e.g., enhanced processor management algorithms, AI algorithms, hash algorithms, data compression algorithms, data decompression algorithms, and/or other algorithm), interfaces, protocols, tools, and/or other information, to facilitate operation of the processor manager component 126, and control data flow between the processor manager component 126 and/or other components (e.g., network equipment or components, the RAN 106 or another RAN, a base station of the RAN(s), the communication network 102, a device (e.g., 112 or 114), a node, an application, a service, a user, or other entity) associated with the processor manager component 126.

The data store 1118 can store data structures (e.g., user data, metadata), code structure(s) (e.g., modules, objects, hashes, classes, procedures) or instructions, information relating to data, files, services, applications, RANs, cells, communication network, core network, devices, users, resources, processing unit cores, baseband processing, QoS, attributes, conditions, duplex type, active spectrum, spectrum utilization, spectrum efficiency, TTI, processing unit core allocation, processing unit core utilization, latency, operational states of processing unit cores, data traffic, frequencies of processing unit cores, devices scheduled per TTI, communication sessions, AI/ML-based models, AI-related data, training data, feedback information, measurement reports, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined processor management criteria, algorithms (e.g., enhanced processor management algorithms, AI algorithms, hash algorithms, data compression algorithms, data decompression algorithms, and/or other algorithm), interfaces, protocols, tools, and/or other information, to facilitate controlling or performing operations associated with the processor manager component 126. The data store 1118 can comprise volatile and/or non-volatile memory, such as described herein. In an aspect, the processor component 1116 can be functionally coupled (e.g., through a memory bus) to the data store 1118 in order to store and retrieve information desired to operate and/or confer functionality, at least in part, to the monitor component 1102, condition detector component 1104, processor unit core controller component 1106, trend determinator component 1108, AI component 1110, the processor component 1116, the data store 1118, and/or other component of the processor manager component 126, and/or substantially any other operational aspects of processor manager component 126.

As disclosed, the data store 1118 can comprise volatile memory and/or nonvolatile memory. By way of example and not limitation, nonvolatile memory can include read only memory (ROM), programmable ROM (PROM), electrically programmable ROM (EPROM), electrically erasable ROM (EEPROM), flash memory, non-volatile memory express (NVMe), NVMe over fabric (NVMe-oF), persistent memory (PMEM), or PMEM-oF. Volatile memory can include random access memory (RAM), which can act as external cache memory. By way of example and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

With further regard to the AI component 1110, in accordance with various embodiments, the AI component 1110 and/or the model 1114 can perform an AI-based analysis on data, such as information relating to communication sessions, data traffic, attributes, conditions, energy consumption, operations, functions, parameters, events, venues, buildings, highways or roads, and/or other features associated with the RAN 106 and/or devices (e.g., device 112 and/or device 114), and/or the core network 104, and/or feedback information (e.g., feedback information from a user, a device, a base station, network equipment or network function of the core network 104, or another data source). In some embodiments, with regard to a model 1114, the AI component 1110 can input such information into the (trained) model 1114 for analysis (e.g., AI-based analysis) by the model 1114 to update the model 1114 or to generate output results (e.g., AI-related data relating to conditions of attributes associated with the RAN 106, QoS associated with the RAN 106, energy consumption of the RAN 106, allocation and/or operational states of processing unit cores, and/or other output results) based at least in part on the analysis of the input information.

In connection with or as part of such an AI-based analysis, the AI component 1110 can employ, build (e.g., construct or create), and/or import, AI-based techniques and algorithms, AI-based models 1114 (e.g., untrained or trained models), neural networks (e.g., untrained or trained neural networks), decision trees, Markov chains (e.g., trained Markov chains), and/or graph mining to render and/or generate predictions, inferences, calculations, prognostications, estimates, derivations, forecasts, detections, and/or computations that can facilitate determining or learning data patterns in data, determining or learning a correlation, relationship, or causation between an item(s) of data and another item(s) of data (e.g., occurrence of the other item(s) of data or an event relating thereto), determining or learning a correlation, relationship, or causation between an event and another event (e.g., occurrence of another event), determining or learning about conditions of attributes associated with the RAN 106, determining or learning about QoS (e.g., perceived QoS) associated with data traffic and the RAN 106 and relationships between the QoS and other attributes, determining or learning about energy consumption of the RAN 106 in relation to resource usage (e.g., allocation and/or operational states of processing unit cores), determining or learning about data traffic associated with communication sessions between the RAN 106 and devices (e.g., 112 or 114), determining or learning about events, venues, locations, highways or roads, and/or buildings, associated with the RAN 106, performing other desired functions or operations, and/or automating one or more functions or features of the disclosed subject matter, as more fully described herein.

The AI component 1110 can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein with regard to the disclosed subject matter, the AI component 1110 can examine the entirety or a subset of the data (e.g., the training data; the operational data relating to the communication network 102, the core network 104, a device (e.g., device 112 and/or device 114), the RAN 106, a base station, and/or the services; the feedback information; and/or other information, such as described herein) to which it is granted access and can provide for reasoning about or determine states of the system and/or environment from a set of observations as captured via events and/or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events and/or data.

In some embodiments, with regard to probabilities, the AI component 1110 and/or the trained model(s) 1114 can employ one or more threshold probabilities (e.g., threshold probability values) to facilitate making a determination. For instance, in making a determination (e.g., relating to data traffic, operations of the RAN 106, operations of a device(s), conditions of attributes associated with the RAN 106, QoS associated with the RAN 106, energy consumption of the RAN 106, allocation and/or operational states of processing unit cores, or other determination), as part of the AI-based analysis of information, the AI component 1110 and/or the trained model(s) 114 can determine a probability (e.g., a probability of a QoS associated with the device (e.g., at a future time), a probability of a condition of an attribute, a probability that a particular allocation and/or particular operational states of processing unit cores can enable the QoS associated with the RAN 106 to satisfy the defined threshold QoS, or other probability relating to operation of the RAN 106), and can determine whether the probability (e.g., probability value) satisfies (e.g., meets or exceeds; or is at or greater than) a defined and applicable threshold probability. The AI component 1110 and/or the trained model(s) 1114 can make a determination (or prediction or inference) (e.g., relating to conditions of attributes associated with the RAN 106, QoS associated with the RAN 106, energy consumption of the RAN 106, and/or allocation and/or operational states of processing unit cores) based at least in part on the results of analyzing (e.g., comparing) the probability to the defined and applicable threshold probability (e.g., threshold minimum probability value). As a non-limiting example, the AI component 1110 and/or the trained model(s) 1114 can make a determination (or prediction or inference) that a particular allocation and/or particular operational states of processing unit cores can enable the QoS associated with the RAN 106 to satisfy the defined threshold QoS (e.g., while enabling the RAN 106 to consume a desirably lower (e.g., reduced, lowest, or minimal) amount of energy) based at least in part on determining that a probability relating to (e.g., indicating) the particular allocation and/or particular operational states of processing unit cores satisfies the defined and applicable threshold probability (e.g., the probability is the highest probability, relative to other probabilities associated with other allocations of processing unit cores and/or other operational states of processing unit cores, and satisfies the defined and applicable threshold probability).

Such determinations can result in the construction of new events or actions from a set of observed events and/or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes and/or systems (e.g., support vector machines, neural networks, expert systems, Bayesian belief networks, fuzzy logic, data fusion engines, and so on) in connection with performing automatic and/or determined action in connection with the claimed subject matter. Thus, classification schemes and/or systems can be used to automatically learn and perform a number of functions, actions, and/or determinations.

In some embodiments, the AI component 1110 can employ a classifier that can perform an AI-based analysis on data. A classifier can map an input attribute vector, z=(z1, z2, z3, z4, . . . , zn), to a confidence that the input belongs to a class, as by f(z)=confidence(class). Such classification can employ a probabilistic and/or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and/or probabilistic classification models providing different patterns of independence, any of which can be employed. Classification as used herein also is inclusive of statistical regression that is utilized to develop models of priority.

In some embodiments, the AI component 1110 (e.g., employing the trainer component 1112) can comprise, generate, and/or train (e.g., iteratively train) AI-based models 1114 that can be trained to learn, determine, predict, or infer data patterns in data; a correlation, relationship, or causation between an item(s) of data and another item(s) of data (e.g., occurrence of the other item(s) of data or an event relating thereto); a correlation, relationship, or causation between an event and another event (e.g., occurrence of another event); relationships between components (e.g., RAN 106, cells, network nodes, communication links, devices, or other components or functions) of or associated with the communication network 102; data traffic (e.g., type of data traffic, amount of data traffic, or other characteristic of data traffic) associated with communication sessions between the RAN 106 station and devices (e.g., 112 and/or 114); parameters or configurations of the RAN 106; conditions of attributes associated with the RAN 106; QoS associated with the RAN 106; energy consumption of the RAN 106; allocation and/or operational states of processing unit cores; and/or an effect on performance, QoS, and/or energy consumption associated with the RAN 106 as a result of modification of allocation and/or operational states of processing unit cores; and/or to perform other desired functions or operations, and/or to automate one or more functions or features of the disclosed subject matter, as described herein.

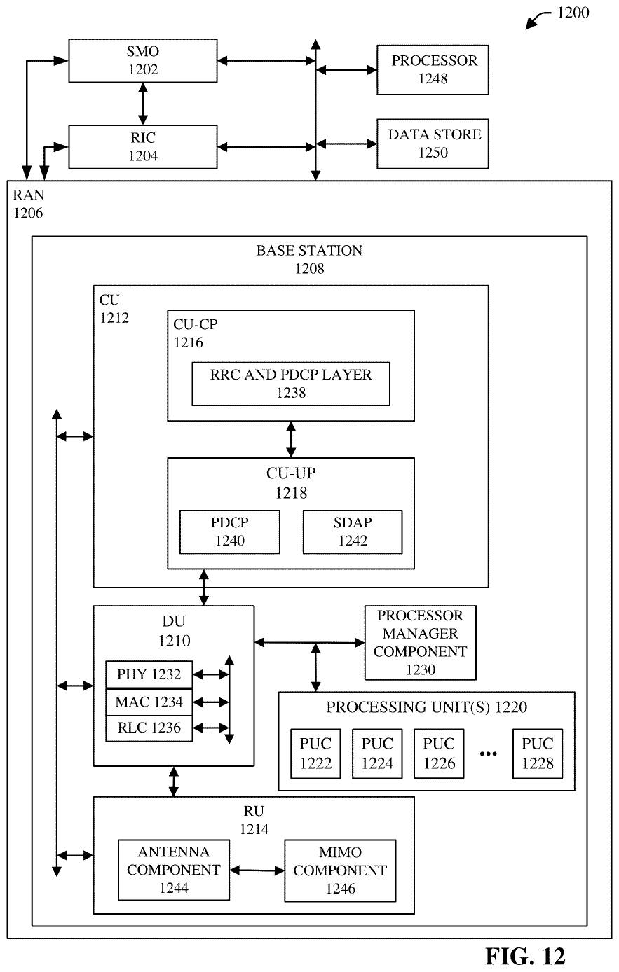

Turning to FIG. 12 (along with FIGS. 1 and 2), FIG. 12 depicts a block diagram of non-limiting example system 1200 that can comprise the processor manager component in the RAN in an O-RAN communication network environment to facilitate desirable (e.g., suitable, reliable, efficient, enhanced, and/or optimal) management of resources, including processing unit cores, associated with the RAN to facilitate satisfying QoS associated with the RAN while also having the RAN utilize (e.g., consume) a desirably lower (e.g., reduced, lowest, or minimized) amount of energy, in accordance with various aspects and embodiments of the disclosed subject matter. In some embodiments, the system 1200 can be part of the system 100 depicted in FIG. 1.

The system 1200 can comprise a service management and orchestration (SMO) 1202, a RIC 1204, and a RAN 1206. In some embodiments, the RAN 1206 can be an O-RAN that can be part of an O-RAN architecture and environment (e.g., the communication network 102 can employ an O-RAN architecture and environment). In certain embodiments, the RAN 1206 can be a cloud-based or centralized RAN (C-RAN) that can be part of a cloud or centralized RAN (C-RAN), or a virtual RAN (vRAN) that can be part of a vRAN architecture and environment (e.g., the communication network 102 can employ a C-RAN or vRAN architecture and environment). In still other embodiments, the RAN 1206 may not be an O-RAN, C-RAN, or vRAN.

In accordance with various embodiments, the RAN 1206 and associated communication network (e.g., communication network 102) can be part of a 5G or other new radio (NR) communication environment (e.g., an xG communication environment, wherein x can be 5 or a number greater than 5). With regard to 5G or other NR generation, the RAN 1206 can comprise base stations, such as a gNodeB (gNB or NR-NB), that can be disaggregated into a CU (e.g., gNB or other NR-NB CU), comprising a CU-user plane (CU-UP) (e.g., gNB or other NR-NB CU-UP), a CU-control plane (CU-CP) (e.g., gNB or other NR-NB CU-CP), and a DU (e.g., gNB or other NR-NB DU). The CU-UP and DU can be part of the user plane node, with the CU-UP hosting PDCP and SDAP entities, and the DU can host the RLC, MAC, and PHY layers. For instance, the RAN 1206 can comprise the base station 1208 that can comprise a DU 1210, a CU 1212, and a radio unit (RU) 1214 (e.g., a gNB or other NR-NB RU). The CU 1212 can comprise a CU-CP 1216 (also referred to as a CU-CP node) and a CU-UP 1218 (also referred to as a CU-UP node). In certain embodiments, the RAN 1206 and/or the base station 1208 can comprise multiple DUs, multiple CU-CPs, multiple CU-UPs, and/or multiple RUs. In some embodiments, the DU 1210, the CU 1212, and the RU 1214 can be co-located at a cell site. In other embodiments, the RAN 1206 can be a disaggregated RAN where one or more of the components (e.g., the CU 1212, or at least part of the CU 1212, such as the CU-CP 1216) of the base station 1208 can be located in different location than one or more other components (e.g., DU 1210, RU 1214, and/or CU-UP 1218) of the base station 1208.

In accordance with various embodiments, the system 1200 can comprise one or more processing units 1220 that can be associated with (e.g., communicatively connected to or part of) the DU 1210, the RU 1214, and/or another component of or associated with the base station 1208. In some embodiments, if the RAN 1206 is a disaggregated RAN, the one or more processing units 1220 (e.g., one or more CPUs or GPP-based servers) can be co-located with the DU 1210 and/or other components of the RAN 1206. The one or more processing units 1220 can comprise the group of processing unit cores, which can comprise, for example, processing unit cores 1222, 1224, 1226, and/or 1228 that can function and operate as described herein.

In some embodiments, the system 1200 also can comprise the processor manager component 1230 that can be associated with the DU 1210, the one or more processing units 1220, and/or other components of the RAN 1206. The processor manager component 1230 can comprise various components and functions, and can perform various operations, such as described herein. In certain embodiments, the processor manager component 1230 can desirably manage resources, including the group of processing unit cores (e.g., 1222, 1224, 1226, and/or 1228), of the RAN 1206 to facilitate satisfying QoS associated with the RAN 1206 while also utilizing (e.g., consuming) a desirably lower (e.g., reduced, lowest, or minimized) amount of energy, in accordance with the defined processor management criteria, such as described herein.

The DU 1210 can be a logical node that can host or handle baseband (e.g., physical layer (PHY) 1232 (e.g., L1 layer)) and L2 (e.g., a MAC layer 1234 and a radio link control (RLC) layer 1236) functionality associated with the base station 1208. The CU-CP 1216 can be a logical node that can host or handle L3 (e.g., a radio resource control (RRC) and packet data convergence protocol (PDCP) layer 1238) control plane functionality associated with the base station 1208. The CU-UP 1218 can be a logical node that can host or handle data traffic between the core network 104 (e.g., 5G core network) and one or more DUs (e.g., the DU 1210) to which the CU-UP 1218 is connected. In some embodiments, the CU-UP 1218 can comprise a PDCP component (PDCP) 1240 that can perform PDCP functions, and a service data adaptation protocol (SDAP) component (SDAP) 1242 that can perform SDAP functions.

The RU 1214 can be or can comprise a logical node that can host a lower PHY layer and radio frequency (RF) processing, where signals (e.g., RF signals) can be transmitted, received, amplified, digitized, or otherwise processed, to facilitate communication of information (e.g., signals comprising information) between the RAN 1206 and other devices (e.g., devices 112 and/or 114) or components (e.g., components or functions of the core network 104 or communication network 102). In some embodiments, the RU 1214 can comprise an antenna component 1244 that can comprise an antenna array that can comprise a desired number of transmitter and receiver antennas to facilitate transmission and receiving of signals comprising information, and perform various beamforming, antenna-related, and communication-related functions. The RU 1214 also can comprise a MIMO component 1246 that can be employed to generate or modify a number of MIMO spatial layers and a number of spatial streams employed by the base station 1208 (e.g., with regard to a device(s)) during a communication session between the base station 1208 and a device (e.g., device 112), and perform MIMO spatial multiplexing functions. In certain embodiments, the MIMO component 1246 can be configured in a single user (SU)-type MIMO mode or a multiple user (MU)-type MIMO mode. In some embodiments, the MIMO component 1246 can employ or support massive MIMO (mMIMO). The RU 1214 also can comprise or be associated with other functions, including, for example, modulation and coding scheme (MCS) functions and transmit diversity functions.

In some embodiments, as disclosed, the system 1200 can comprise an O-RAN architecture and environment, and the RAN 1206 can be an O-RAN. In some embodiments, in the O-RAN architecture and environment, the SMO component 1202 can be associated with (e.g., communicatively connected to) the RIC 1204 and/or the RAN 1206 (and/or one or more other RANs) via an interface(s) (e.g., an O1 interface, an A1 interface, or another interface), to facilitate communication of information between the SMO component 1202 and the RIC 1204 and/or the RAN 1206 (and/or one or more other RANs), and the RIC 1204 can be associated with the RAN 1206 (and/or one or more other RANs) via an interface(s) (e.g., an E2 interface or another interface), to facilitate communication of information between the RIC 1204 and the RAN 1206 (and/or one or more other RANs).

The SMO component 1202 can act and operate as a management and orchestration layer that can control configuration and automation aspects of the RIC 1204 and RAN elements of the RAN(s) 1206. The SMO component 1202 can comprise various types of management services and various network functions, comprising network management functions, which can include RAN-type or RAN-related functions, core management functions, transport management functions, network slice management functions (e.g., end-to-end network slice management functions), and/or other network management functions. In accordance with various embodiments, the network functions can be or can comprise physical network functions, virtualized network functions (e.g., virtual machines (VMs), containers, or other virtualized network functions). At least some of the various network functions (e.g., network management functions or other network functions) can operate in real time or near real time.

The RIC 1204 can operate to control (e.g., manage) and enhance (e.g., improve or optimize) RAN functions and services of the RAN(s) 1206. At least some of the various network functions and components of the RIC 1204 can operate in real time or near real time, and some network functions and components of the RIC 1204 may operate in non-real time.

In accordance with various embodiments, the system 1200 can comprise a processor component 1248 that can be associated with (e.g., communicatively connected to) and can work in conjunction with other components of the system 1200, including the SMO component 1202, the RIC 1204, the RAN 1206, the one or more processing units 1220, the processor manager component 1230, a data store 1250, and/or other components of the system 1200, to facilitate performing the various functions and operations of the system 1200. The processor component 1248 can employ one or more processors (e.g., one or more CPUs, accelerators, GPUs, ASICs, or other processors), microprocessors, or controllers that can process information relating to data, files, services, applications, RANs, cells, communication network, core network, devices, users, resources, processing unit cores, baseband processing, QoS, attributes, conditions, duplex type, active spectrum, spectrum utilization, spectrum efficiency, TTI, processing unit core allocation, processing unit core utilization, latency, operational states of processing unit cores, data traffic, frequencies of processing unit cores, devices scheduled per TTI, communication sessions (e.g., PDU or other communication sessions), AI/ML-based models, AI-related data, training data, feedback information, measurement reports, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined processor management criteria, algorithms (e.g., enhanced processor management algorithms, AI algorithms, hash algorithms, data compression algorithms, data decompression algorithms, and/or other algorithm), interfaces, protocols, tools, and/or other information, to facilitate operation of the system 1200, and control data flow between the system 1200 and/or other components (e.g., network equipment, components, or functions, the communication network 102, the core network 104, another base station, a device (e.g., 112 or 114), a node, an application, a service, a user, or other entity) associated with the system 1200.

The data store 1250 can store data structures (e.g., user data, metadata), code structure(s) (e.g., modules, objects, hashes, classes, procedures) or instructions, information relating to data, files, services, applications, RANs, cells, communication network, core network, devices, users, resources, processing unit cores, baseband processing, QoS, attributes, conditions, duplex type, active spectrum, spectrum utilization, spectrum efficiency, TTI, processing unit core allocation, processing unit core utilization, latency, operational states of processing unit cores, data traffic, frequencies of processing unit cores, devices scheduled per TTI, communication sessions (e.g., PDU or other communication sessions), AI/ML-based models, AI-related data, training data, feedback information, measurement reports, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined processor management criteria, algorithms (e.g., enhanced processor management algorithms, AI algorithms, hash algorithms, data compression algorithms, data decompression algorithms, and/or other algorithm), interfaces, protocols, tools, and/or other information, to facilitate controlling or performing operations associated with the system 1200. The data store 1250 can comprise volatile and/or non-volatile memory, such as described herein. In an aspect, the processor component 1248 can be functionally coupled (e.g., through a memory bus) to the data store 1250 in order to store and retrieve information desired to operate and/or confer functionality, at least in part, to the SMO component 1202, the RIC 1204, the RAN 1206, the one or more processing units 1220, the processor manager component 1230, the processor component 1248, the data store 1250, and/or other component of the system 1200, and/or substantially any other operational aspects of system 1200.

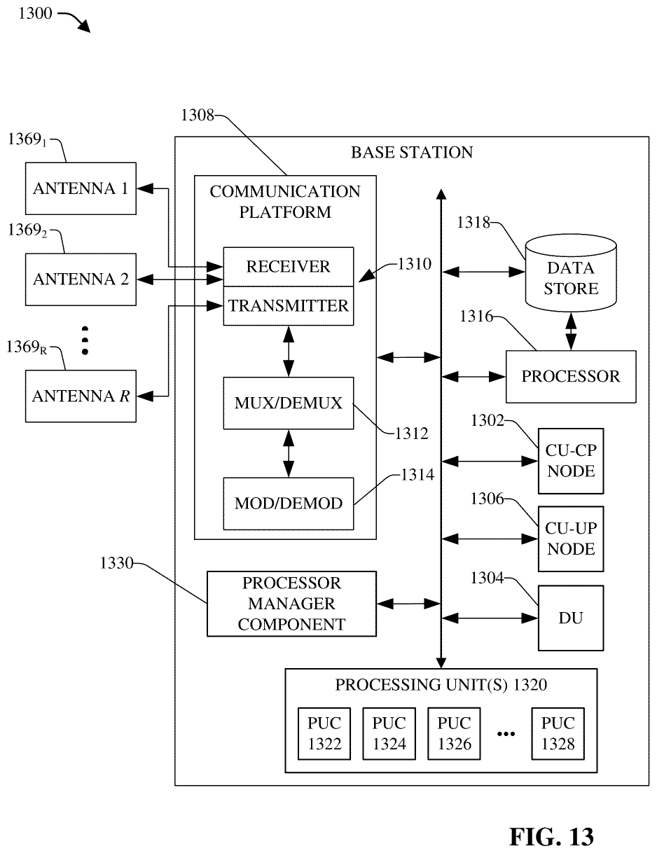

Turning to FIG. 13, FIG. 13 depicts a diagram of a non-limiting example base station 1300 that can desirably facilitate (e.g., enable) connections (e.g., wireless connections) and communication of information associated with devices, in accordance with various aspects and embodiments of the disclosed subject matter. In some embodiments, the base station 1300 can be a 5G or other NR base station (e.g., gNB or other NR-type or xG base station, wherein x can be a number greater than 5). In other embodiments, the base station 1300 can be a 4G or LTE base station, can be a base station that can comprise 5G/NR functionality and 4G/LTE functionality, or can be some other type of base station (e.g., other type of access point).

With regard to a 5G or other NR base station, the base station 1300 can comprise a CU-CP node 1302 (e.g., a gNB or other NR-NB CU-CP node), one or more DUs (e.g., a gNB or other NR-NB DUs), including DU 1304, a desired number of CU-UP nodes (e.g., a gNB or other NR-NB CU-UP nodes), including CU-UP node 1306, and/or other network equipment. The CU-CP node 1302 can be associated or interfaced with the DUs (e.g., DU 1304) via an interface (e.g., F1-C interface) or connection. The CU-CP node 1302 can be associated or interfaced with the CU-UP nodes (e.g., CU-UP node 1306) via an interface (e.g., E1 interface) or connection. The one or more CU-UP nodes (e.g., CU-UP node 1306) can be associated or interfaced with the one or more DUs (e.g., DU 1304) via an interface (e.g., F1-U interface) or connection.

A DU (e.g., DU 1304) can provide support for lower layers of a protocol stack. For instance, a DU (e.g., DU 1304) can be a logical node that can host or handle baseband (e.g., PHY) and L2 (e.g., MAC and RLC layer) functionality associated with the base station 1300. A CU-UP node (e.g., CU-UP node 1306) can be a logical node that can host or handle data traffic between the core network 104 (e.g., 5G or other NR or xG core network) and the DU(s) (e.g., DU 1304) to which the particular CU-UP is connected. The CU-CP node 1302 can be a logical node that can host or handle L3 (e.g., RRC and PDCP layer) control plane functionality associated with the base station 1300.

In some embodiments, a device(s) (e.g., device(s) 112 and/or 114) can be connected to the base station 1300, via the DU 1304, wherein the CU-UP node 1306 and the DU 1304 can be serving the device by performing or facilitating performing downlink data transfers of downlink data to the device from a data source (e.g., a service and/or another device, or a network component of the communication network 102 or core network 104 (e.g., via the UPF node)), and uplink data transfers of uplink data from the device to a desired destination (e.g., the data source) via the base station 1300.

The base station 1300 can receive and transmit signal(s) from and to wireless devices like access points (e.g., base stations, femtocells, picocells, or other type of access point), access terminals (e.g., UEs), wireless ports and routers, and the like, through a set of antennas 13691-1369R. In an aspect, the antennas 13691-1369R can be a part of a communication platform 1308, which comprises electronic components and associated circuitry that can provide for processing and manipulation of received signal(s) and signal(s) to be transmitted. In an aspect, the communication platform 1308 can include a receiver/transmitter 1310 that can convert signal from analog to digital upon reception, and from digital to analog upon transmission. In addition, receiver/transmitter 1310 can divide a single data stream into multiple, parallel data streams, or perform the reciprocal operation. In accordance with various embodiments, the communication platform 1308 can be, can comprise, or can be associated with an RU (e.g., a gNB or other NR-NB RU node).

In an aspect, coupled to receiver/transmitter 1310 can be a multiplexer/demultiplexer (mux/demux) 1312 that can facilitate manipulation of signal in time and frequency space. The mux/demux 1312 can multiplex information (e.g., data/traffic and control/signaling) according to various multiplexing schemes such as, for example, time division multiplexing (TDM), frequency division multiplexing (FDM), orthogonal frequency division multiplexing (OFDM), code division multiplexing (CDM), space division multiplexing (SDM), etc. In addition, mux/demux component 1312 can scramble and spread information (e.g., codes) according to substantially any code known in the art, e.g., Hadamard-Walsh codes, Baker codes, Kasami codes, polyphase codes, and so on. A modulator/demodulator (mod/demod) 1314 also can be part of the communication platform 1308, and can modulate information according to multiple modulation techniques, such as frequency modulation, amplitude modulation (e.g., M-ary quadrature amplitude modulation (QAM), with M a positive integer), phase-shift keying (PSK), and the like.

The base station 1300 also can comprise a processor(s) 1316 that can be configured to confer and/or facilitate providing functionality, at least partially, to substantially any electronic component in or associated with the base station 1300. For instance, the processor(s) 1316 can facilitate operations on data (e.g., symbols, bits, or chips) for multiplexing/demultiplexing, modulation/demodulation, such as effecting direct and inverse fast Fourier transforms, selection of modulation rates, selection of data packet formats, inter-packet times, and/or other operations on data.

In another aspect, the base station 1300 can include a data store 1318 that can store data structures; code instructions; rate coding information; information relating to measurement of radio link quality or reception of information related thereto; information relating to devices, communication conditions or performance indicators associated with devices (e.g., signal-to-interference-plus-noise ratio (SINR), reference signal received power (RSRP), reference signal received quality (RSRQ), channel quality indicator (CQI), and/or other wireless communications metrics or parameters) associated with devices; information relating to data, files, services, applications, RANs, cells, communication network, core network, devices, users, resources, processing unit cores, baseband processing, QoS, attributes, conditions, duplex type, active spectrum, spectrum utilization, spectrum efficiency, TTI, processing unit core allocation, processing unit core utilization, latency, operational states of processing unit cores, data traffic, frequencies of processing unit cores, devices scheduled per TTI, communication sessions, AI/ML-based models, AI-related data, training data, feedback information, measurement reports, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined processor management criteria, algorithms (e.g., enhanced processor management algorithms, AI algorithms, hash algorithms, data compression algorithms, data decompression algorithms, and/or other algorithm), interfaces, protocols, tools, and/or other information; white list information, information relating to managing or maintaining the white list; system or device information like policies and specifications; code sequences for scrambling; spreading and pilot transmission; floor plan configuration; base station deployment and frequency plans; scheduling policies; and so on.

The processor(s) 1316 can employ one or more processors (e.g., one or more CPUs, accelerators, GPUs, ASICs, or other processors), microprocessors, or controllers) that can process information, and can be coupled to the data store 1318 in order to store and retrieve at least some of the information (e.g., information, such as algorithms, relating to multiplexing/demultiplexing or modulation/demodulation; information relating to radio link levels; information relating to data, files, services, applications, RANs, cells, communication network, core network, devices, users, resources, processing unit cores, baseband processing, QoS, attributes, conditions, duplex type, active spectrum, spectrum utilization, spectrum efficiency, TTI, processing unit core allocation, processing unit core utilization, latency, operational states of processing unit cores, data traffic, frequencies of processing unit cores, devices scheduled per TTI, communication sessions, AI/ML-based models, AI-related data, training data, feedback information, measurement reports, predictions, inferences, threshold (e.g., maximum, minimum, or other threshold) values, weight values, data processing operations, messages, notifications, alarms, alerts, preferences (e.g., user or client preferences), hash values, metadata, parameters, hyperparameters, traffic flows, tables, mappings, policies, the defined processor management criteria, algorithms (e.g., enhanced processor management algorithms, AI algorithms, hash algorithms, data compression algorithms, data decompression algorithms, and/or other algorithm), interfaces, protocols, tools, and/or other information) desired to operate and/or confer functionality to the communication platform 1308 and/or other operational components of the base station 1300. The data store 1318 can comprise volatile memory and/or nonvolatile memory, such as described herein.

In accordance with various embodiments, the base station 1300 can comprise one or more processing units 1320 that can be associated with (e.g., communicatively connected to or part of) the DU 1304, and/or another component of or associated with the base station 1300. In some embodiments, if the RAN is a disaggregated RAN, the one or more processing units 1320 can be co-located with the DU 1210 and/or other components of the RAN. The one or more processing units 1320 can comprise the group of processing unit cores, which can comprise, for example, processing unit cores 1322, 1324, 1326, and/or 1328 that can function and operate as described herein.

In some embodiments, the base station 1300 also can comprise the processor manager component 1330 that can be associated with the DU 1304, the one or more processing units 1320, and/or other components of the RAN. The processor manager component 1330 can comprise various components and functions, and can perform various operations, such as described herein. In certain embodiments, the processor manager component 1330 can desirably manage resources, including the group of processing unit cores (e.g., 1322, 1324, 1326, and/or 1328), of the RAN to facilitate satisfying QoS associated with the RAN while also utilizing (e.g., consuming) a desirably lower (e.g., reduced, lowest, or minimized) amount of energy, in accordance with the defined processor management criteria, such as described herein.

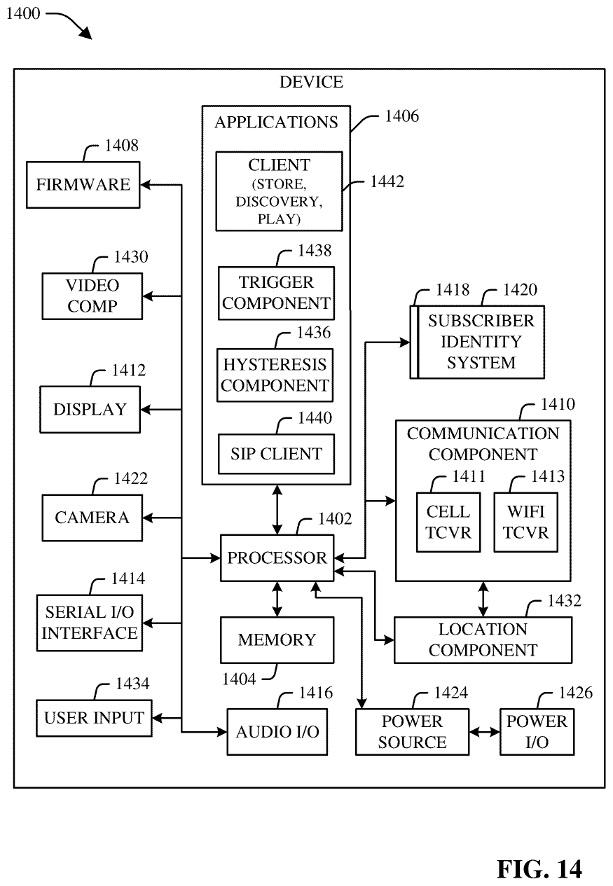

Referring to FIG. 14, FIG. 14 illustrates a diagram of a non-limiting example device 1400 (e.g., wireless or mobile phone, electronic pad or tablet, electronic eyewear, electronic watch, other electronic bodywear, IoT device, or other type of communication device or UE) that can be operable to engage in a system architecture that facilitates wireless communications according to one or more embodiments described herein, in accordance with various aspects and embodiments of the disclosed subject matter. Although a device is illustrated herein, it will be understood that other devices can be a communication device, and that the device 1400 is merely illustrated to provide context for the embodiments of the various embodiments described herein. The following discussion is intended to provide a brief, general description of an example of a suitable environment in which the various embodiments can be implemented. While the description includes a general context of computer-executable instructions embodied on a machine-readable storage medium, those skilled in the art will recognize that the disclosed subject matter also can be implemented in combination with other program modules and/or as a combination of hardware and software.

Generally, applications (e.g., program modules) can include routines, programs, components, data structures, etc., that perform particular tasks or implement particular abstract data types. Moreover, those skilled in the art will appreciate that the methods described herein can be practiced with other system configurations, including single-processor or multiprocessor systems, minicomputers, mainframe computers, as well as personal computers, hand-held computing devices, microprocessor-based or programmable consumer electronics, and the like, each of which can be operatively coupled to one or more associated devices.

A computing device, such as the device 1400, can typically include a variety of machine-readable media. Machine-readable media can be any available media that can be accessed by the computer and includes both volatile and non-volatile media, removable and non-removable media. By way of example and not limitation, computer-readable media can comprise computer storage media and communication media. Computer storage media can include volatile and/or non-volatile media, removable and/or non-removable media implemented in any method or technology for storage of information, such as computer-readable instructions, data structures, program modules, or other data. Computer storage media can include, but is not limited to, RAM, ROM, EEPROM, flash memory or other memory technology, solid state drive (SSD) or other solid-state storage technology, Compact Disk Read Only Memory (CD ROM), digital video disk (DVD), Blu-ray disk, or other optical disk storage, magnetic cassettes, magnetic tape, magnetic disk storage or other magnetic storage devices, or any other medium which can be used to store the desired information and which can be accessed by the computer. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Communication media typically embodies computer-readable instructions, data structures, program modules, or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of the any of the above should also be included within the scope of computer-readable media.

The device 1400 can include a processor(s) 1402 for controlling and processing all onboard operations and functions. The processor(s) 1402 can comprise one or more processors (e.g., one or more CPUs, accelerators, GPUs, ASICs, or other processors), microprocessors, or controllers) that can process information associated with the device 1400. A memory 1404 can interface to the processor(s) 1402 for storage of data and one or more applications 1406 (e.g., a video player software, user feedback component software, or other application). Other applications can include voice recognition of predetermined voice commands that facilitate initiation of the user feedback signals. Still other applications can comprise an AI application. The applications 1406 can be stored in the memory 1404 and/or in a firmware 1408, and executed by the processor(s) 1402 from either or both the memory 1404 or/and the firmware 1408. The firmware 1408 can also store startup code for execution in initializing the device 1400. A communication component 1410 interfaces to the processor(s) 1402 to facilitate wired/wireless communication with external systems, e.g., cellular networks, VoIP networks, and so on. Here, the communication component 1410 can also include a suitable cellular transceiver 1411 (e.g., a global system for mobile communication (GSM), orthogonal frequency division multiple access (OFDMA), 4G, LTE, 5G, other NR, or other type of transceiver) and/or an unlicensed transceiver 1413 (e.g., Wi-Fi, WiMax) for corresponding signal communications. The device 1400 can be a device such as a cellular telephone, a PDA with mobile communications capabilities, and messaging-centric devices. The communication component 1410 also facilitates communications reception from terrestrial radio networks (e.g., broadcast), digital satellite radio networks, and Internet-based radio services networks.

The device 1400 includes a display 1412 for displaying text, images, video, telephony functions (e.g., a Caller ID function), setup functions, and for user input. For example, the display 1412 can also be referred to as a “screen” that can accommodate the presentation of multimedia content (e.g., music metadata, messages, wallpaper, graphics, etc.). The display 1412 can also display videos and can facilitate the generation, editing and sharing of video quotes. A serial I/O interface 1414 is provided in communication with the processor(s) 1402 to facilitate wired and/or wireless serial communications (e.g., USB, and/or IEEE 1394) through a hardwire connection, and other serial input devices (e.g., a keyboard, keypad, and mouse). This supports updating and troubleshooting the device 1400, for example. Audio capabilities are provided with an audio I/O component 1416, which can include a speaker for the output of audio signals related to, for example, indication that the user pressed the proper key or key combination to initiate the user feedback signal. The audio I/O component 1416 also facilitates the input of audio signals through a microphone to record data and/or telephony voice data, and for inputting voice signals for telephone conversations.

The device 1400 can include a slot interface 1418 for accommodating a SIC (Subscriber Identity Component) in the form factor of a card Subscriber Identity Module (SIM) or universal SIM 1420, and interfacing the SIM card 1420 with the processor(s) 1402. However, it is to be appreciated that the SIM card 1420 can be manufactured into the device 1400, and updated by downloading data and software.

The device 1400 can process IP data traffic through the communication component 1410 to accommodate IP traffic from an IP network such as, for example, the Internet, a corporate intranet, a home network, a person area network, etc., through an ISP or broadband cable provider. Thus, VoIP traffic can be utilized by the device 1400 and IP-based multimedia content can be received in either an encoded or a decoded format.

A video processing component 1422 (e.g., a camera) can be provided for decoding encoded multimedia content. The video processing component 1422 can aid in facilitating the generation, editing, and sharing of video quotes. The device 1400 also includes a power source 1424 in the form of batteries and/or an AC power subsystem, which power source 1424 can interface to an external power system or charging equipment (not shown) by a power I/O component 1426.

The device 1400 can also include a video component 1430 for processing video content received and, for recording and transmitting video content. For example, the video component 1430 can facilitate the generation, editing and sharing of video quotes. A location tracking component 1432 facilitates geographically locating the device 1400. As described hereinabove, this can occur when the user initiates the feedback signal automatically or manually. A user input component 1434 facilitates the user initiating the quality feedback signal. The user input component 1434 can also facilitate the generation, editing and sharing of video quotes. The user input component 1434 can include such conventional input device technologies such as a keypad, keyboard, mouse, stylus pen, and/or touch screen, for example.

Referring again to the applications 1406, a hysteresis component 1436 facilitates the analysis and processing of hysteresis data, which is utilized to determine when to associate with the access point. A software trigger component 1438 can be provided that facilitates triggering of the hysteresis component 1436 when the Wi-Fi transceiver 1413 detects the beacon of the access point. A SIP client 1440 enables the device 1400 to support SIP protocols and register the subscriber with the SIP registrar server. The applications 1406 can also include a client 1442 that provides at least the capability of discovery, play and store of multimedia content, for example, music.

The device 1400, as indicated above related to the communication component 1410, includes an indoor network radio transceiver 1413 (e.g., Wi-Fi transceiver). This function supports the indoor radio link, such as IEEE 802.11, for the dual-mode GSM device (e.g., device 1400). The device 1400 can accommodate at least satellite radio services through a device (e.g., handset device) that can combine wireless voice and digital radio chipsets into a single device (e.g., single handheld device).

It is to be appreciated and understood that one or more components (e.g., the devices, configuration manager component, base station, core network, or other component) of the systems (e.g., system 100, system 1200, or other system) or methods described herein can comprise or be associated with various other types of components, such as display screens (e.g., touch screen displays or non-touch screen displays), audio functions (e.g., amplifiers, speakers, or audio interfaces), or other interfaces, to facilitate presentation of information to users, entities, or other components (e.g., other devices or other servers), and/or to perform other desired functions or operations.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

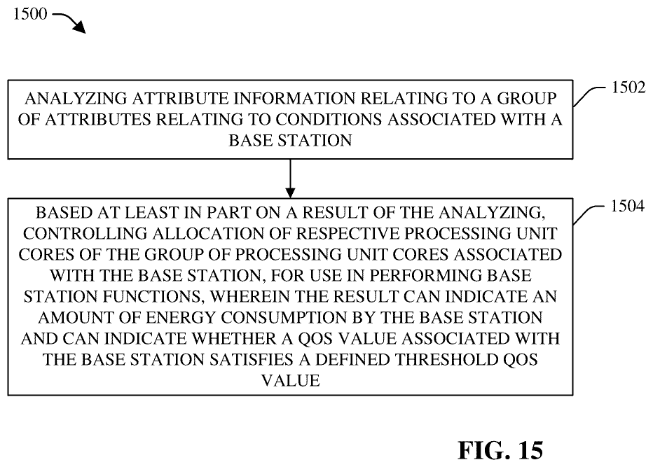

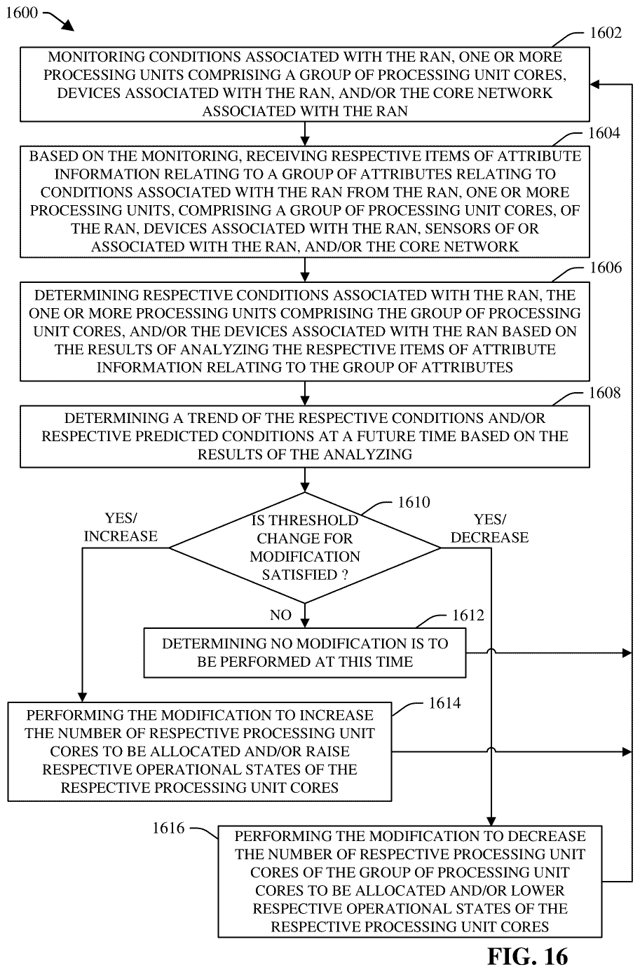

In view of the example systems and/or devices described herein, example methods that can be implemented in accordance with the disclosed subject matter can be further appreciated with reference to flowcharts in FIGS. 15-16. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 15 illustrates a flow chart of an example method 1500 that can desirably (e.g., automatically, dynamically, suitably, reliably, efficiently, enhancedly, and/or optimally) manage resources, including processing unit cores, associated with the RAN to facilitate satisfying QoS associated with the RAN while also having the RAN utilize (e.g., consume) a desirably lower (e.g., reduced, lowest, or minimized) amount of energy, in accordance with various aspects and embodiments of the disclosed subject matter. The method 1500 can be employed by, for example, a system comprising the RAN and the processor manager component that can comprise or be associated with the processor component, the data store, and/or other components.

At 1502, attribute information relating to a group of attributes relating to conditions associated with a base station can be analyzed. The processor manager component can monitor conditions associated with the base station of the RAN (e.g., a disaggregated RAN comprising the DU, the CU, and/or other components), one or more processing units comprising the group of processing unit cores of the RAN, devices associated with the RAN, and the core network. Based at least in part on the monitoring, the processor manager component can receive or detect respective items of attribute information from or associated with the RAN, the one or more processing units, the devices, sensors of or associated with the RAN, the core network, and/or other entities. The processor manager component (e.g., employing the condition detector component) can analyze the attribute information relating to the group of attributes relating to the conditions associated with the base station of the RAN.

At 1504, based at least in part on a result of the analyzing, allocation of respective processing unit cores of the group of processing unit cores associated with the base station, for use in performing base station functions, can be controlled, wherein the result can indicate an amount of energy consumption by the base station and can indicate whether a QoS value associated with the base station satisfies a defined threshold QoS value. For instance, based at least in part on a result of the analyzing, the processor manager component can control the allocation of the respective processing unit cores of the group of processing unit cores associated with the base station for use in performing the base station functions. In some embodiments, the processor manager component (e.g., employing the condition detector component) can determine the respective conditions associated with the RAN, the one or more processing units comprising the group of processing unit cores, the devices associated with the RAN, based at least in part on a result of the analyzing. Based at least in part on the respective conditions, the processor manager component can control the allocation of the respective processing unit cores for use in performing the base station functions, to facilitate ensuring that the QoS value (e.g., perceived QoS value) associated with the RAN satisfies the defined threshold QoS value (e.g., threshold minimum perceived QoS value) and ensuring that the energy (e.g., power) consumption by the RAN can be desirably low (e.g., minimized, substantially minimized, or reduced), such as described herein.

FIG. 16 depicts a flow chart of another example method 1600 that can desirably (e.g., automatically, dynamically, suitably, reliably, efficiently, enhancedly, and/or optimally) manage resources, including processing unit cores, associated with the RAN to facilitate satisfying QoS associated with the RAN while also having the RAN utilize (e.g., consume) a desirably lower (e.g., reduced, lowest, or minimized) amount of energy, in accordance with various aspects and embodiments of the disclosed subject matter. The method 1600 can be employed by, for example, a system comprising the RAN and the processor manager component that can comprise or be associated with the processor component, the data store, and/or other components.

At 1602, conditions associated with the RAN, one or more processing units comprising a group of processing unit cores, devices associated with the RAN, and/or the core network associated with the RAN can be monitored. The processor manager component can monitor the conditions associated with the RAN (e.g., a disaggregated RAN comprising the DU, the CU, and/or other components), the one or more processing units, the devices, and/or the core network.

At 1604, based at least in part on the monitoring, respective items of attribute information relating to a group of attributes relating to conditions associated with the RAN can be received from the RAN, one or more processing units, comprising a group of processing unit cores, of the RAN, devices associated with the RAN, sensors of or associated with the RAN, and/or the core network. Based at least in part on the monitoring, the processor manager component can receive or detect the respective items of attribute information from or associated with the RAN, the one or more processing units, the devices, the sensors, the core network, and/or other entities.

At 1606, respective conditions associated with the RAN, the one or more processing units comprising the group of processing unit cores, and/or the devices associated with the RAN can be determined based at least in part on the results of analyzing the respective items of attribute information relating to the group of attributes. For instance, the processor manager component (e.g., employing the condition detector component) can analyze the attribute information. Based at least in part on the results of such analysis, the processor manager component (e.g., employing the condition detector component) can determine the respective conditions associated with the RAN, the one or more processing units comprising the group of processing unit cores, and/or the devices.

At 1608, a trend of the respective conditions and/or respective predicted conditions at a future time can be determined based at least in part on the results of the analyzing of the respective conditions, respective previous conditions, and/or other information associated with the RAN, the one or more processing units comprising the group of processing unit cores, and/or the devices. For instance, processor manager component and/or an AI-based model can analyze (e.g., perform an analysis and/or an AI-based analysis on) condition information regarding or relating to the respective conditions, previous condition information relating to the respective previous conditions, and/or the other information. The other information can relate to, for example, an upcoming event(s) (e.g., concert, sporting event, or other event where a large group of people, with devices, may gather) that can be located in proximity to the RAN. Based at least in part on the results of such analysis, the processor manager component and/or the AI-based model can determine the trend (e.g., respective trends) of the respective conditions and/or the respective predicted conditions (e.g., the AI-based model can predict respective future conditions (e.g., the respective predicted conditions)) at the future time.

At 1610, based at least in part on the respective conditions, the trend (e.g., respective trends) of the respective conditions, and/or the respective predicted conditions, and/or a defined threshold amount of condition change, a determination can be made regarding whether the defined threshold amount of condition change is satisfied and a modification is to made to allocation of respective processing unit cores of the group of processing unit cores and/or respective operational states of the respective processing unit cores. For instance, the processor manager component can determine whether the modification is to made to the allocation of respective processing unit cores of the group of processing unit cores and/or the respective operational states of the respective processing unit cores, based at least in part on the respective conditions, the trend of the respective conditions, and/or the respective predicted conditions, and/or the defined threshold (e.g., threshold minimum) amount of condition change (e.g., threshold for triggering the modification). The modification (if any is to be made) can relate to, for example, increasing the number of respective processing unit cores that are allocated (e.g., granting another processing unit core(s)) to ensure that the QoS (e.g., perceived QoS level or value) associated with the RAN can be satisfied while utilizing (e.g., consuming, by the RAN) a lower (e.g., lowest) amount of energy, decreasing the number of respective processing unit cores that are allocated (e.g., reclaiming a processing unit core(s)) to lower (e.g., to a lowest level) the amount of energy utilized by the RAN while still ensuring that the QoS associated with the RAN can be satisfied, increasing or raising an operational state of a processing unit core(s) to a higher state to ensure that the QoS associated with the RAN can be satisfied while utilizing a lower (e.g., lowest) amount of energy, or decreasing or lowering an operational state of a processing unit core(s) to a lower state to lower (e.g., to a lowest level) the amount of energy utilized by the RAN while still ensuring that the QoS associated with the RAN can be satisfied. The defined threshold amount of condition change can relate to one or more of the respective conditions, the trend of one or more of the respective conditions, and/or one or more of the predicted conditions.

If it is determined that the defined threshold (e.g., threshold minimum) amount of condition change is not satisfied, at 1612, a determination can be made that no modification is to be performed at this time, and the method 1600 can return back to reference numeral 1602, wherein the conditions can continue to be monitored, such as described herein. For instance, if the processor manager component determines that the defined threshold amount of condition change is not satisfied (e.g., has not been met), the processor manager component can determine that no modification is to be performed at this time, and can continue monitoring the respective attributes and respective conditions. In some embodiments, the processor manager component can transition from the active mode (e.g., a higher (e.g., high) operational mode) to the inactive mode (e.g., a sleep and/or lower (e.g., low) operational mode) for a defined amount of time, or until a triggering event (e.g., to trigger monitoring and analysis of the attributes and conditions) is detected by the processor manager component or another component. After the defined amount of time has elapsed or the triggering event is detected, the processor manager component can transition back into the active mode, and can monitor and analyze the respective attributes and respective conditions.

If, instead, at reference numeral 1610, it is determined that the defined threshold amount of condition change is satisfied (e.g., has been met) and a modification to increase the number of respective processing unit cores of the group of processing unit cores to be allocated and/or raise the respective operational states of the respective processing unit cores is to be performed, at 1614, the modification can be performed to increase the number of respective processing unit cores of the group of processing unit cores to be allocated and/or raise the respective operational states of the respective processing unit cores to ensure that the QoS associated with the RAN can be satisfied while utilizing (e.g., consuming, by the RAN) a desirably lower (e.g., lowest, reduced, or minimized) amount of energy. For instance, if the processor manager component determines that the defined threshold amount of condition change is satisfied, the processor manager component can determine the type (e.g., increase or decrease; and/or grant or reclaim) and/or amount (e.g., extent) of the modification, based at least in part on the results of analyzing the respective conditions, the trend of the respective conditions, and/or the respective predicted conditions, such as described herein. If, based at least in part on such analysis results, the processor manager component determines that the modification can be to increase the number of respective processing unit cores of the group of processing unit cores to be allocated and/or raise the respective operational states of the respective processing unit cores, from such analysis results, the processor manager component can determine the number (e.g., increased number) of respective processing unit cores to be allocated (and/or, correspondingly, the number of additional processing unit cores to be granted) and/or which one or more of the respective processing unit cores is to have its operational state raised and to which operational state it is to be raised to ensure that the QoS associated with the RAN can be satisfied while consuming (e.g., by the RAN) the desirably lower amount of energy, in accordance with the defined processor management criteria, such as described herein. The processor manager component can perform such modification, such as described herein.

Referring again to reference numeral 1610, if, instead, at 1610, it is determined that the defined threshold amount of condition change is satisfied and a modification to decrease the number of respective processing unit cores of the group of processing unit cores to be allocated and/or lower the respective operational states of the respective processing unit cores is to be performed, at 1616, the modification can be performed to decrease the number of respective processing unit cores of the group of processing unit cores to be allocated and/or lower the respective operational states of the respective processing unit cores to desirably lower (e.g., to a lowest, reduced, or minimized level) the amount of energy utilized by the RAN while still ensuring that the QoS associated with the RAN can be satisfied. For instance, as disclosed, if the processor manager component determines that the defined threshold amount of condition change is satisfied, the processor manager component can determine the type and/or amount of the modification, based at least in part on the results of analyzing the respective conditions, the trend of the respective conditions, and/or the respective predicted conditions. If, based at least in part on such analysis results, the processor manager component determines that the modification can be to decrease the number of respective processing unit cores of the group of processing unit cores to be allocated and/or lower the respective operational states of the respective processing unit cores, from such analysis results, the processor manager component can determine the number (e.g., decreased number) of respective processing unit cores to be allocated (and/or, correspondingly, the number of processing unit cores to be reclaimed) and/or which one or more of the respective processing unit cores is to have its operational state lowered and to which operational state it is to be lowered to lower (e.g., to the lowest or minimized level) the amount of energy consumed by the RAN while still ensuring that the QoS associated with the RAN can be satisfied, in accordance with the defined processor management criteria, such as described herein. The processor manager component can perform such modification, such as described herein.

After the modification is performed at reference numeral 1614 or 1616, the method 1600 can return back to reference numeral 1602, wherein the conditions can continue to be monitored, such as described herein. For instance, after the processor manager component performs the modification at reference numeral 1614 or 1616, the processor manager component can continue monitoring the respective attributes and respective conditions, and determining whether a modification (e.g., a next modification) is to be performed with respect to the group of processing unit cores. In some embodiments, after the processor manager component performs the modification at reference numeral 1614 or 1616, the processor manager component can transition to the inactive mode for the defined amount of time, or until the triggering event (if any) is detected by the processor manager component or another component. After the defined amount of time has elapsed or the triggering event is detected, the processor manager component can transition back into the active mode, and can monitor and analyze the respective attributes and respective conditions and proceed from that point, in accordance with the method 1600.

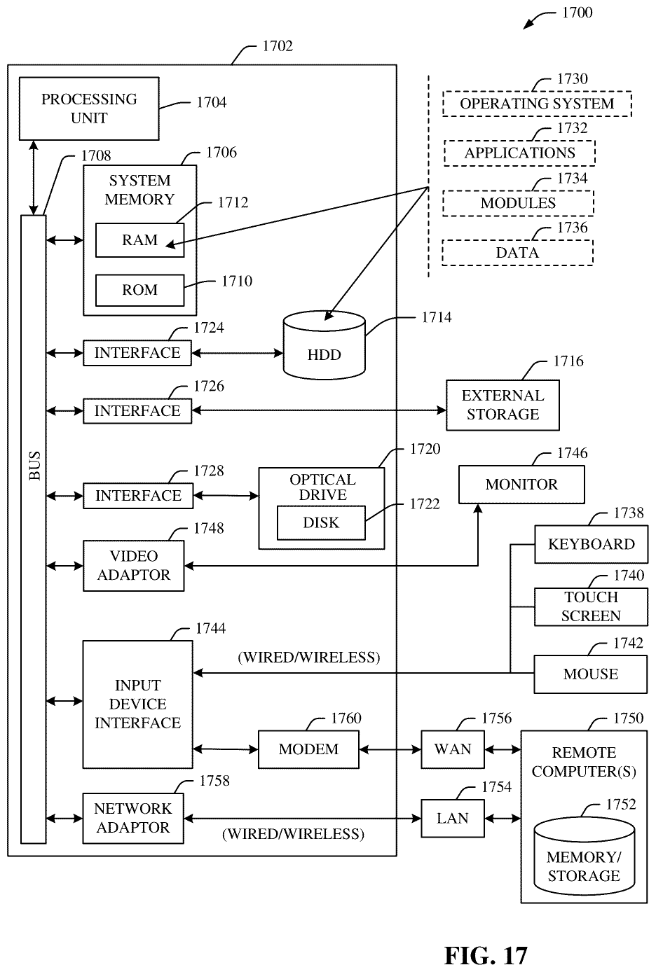

In order to provide additional context for various embodiments described herein, FIG. 17 and the following discussion are intended to provide a brief, general description of a suitable computing environment 1700 in which the various embodiments of the embodiments described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 17, the example environment 1700 for implementing various embodiments of the aspects described herein includes a computer 1702, the computer 1702 including a processing unit 1704, a system memory 1706 and a system bus 1708. The system bus 1708 couples system components including, but not limited to, the system memory 1706 to the processing unit 1704. The processing unit 1704 can be any of various commercially available processors. Dual microprocessors and other multi-processor architectures can also be employed as the processing unit 1704.

The system bus 1708 can be any of several types of bus structure that can further interconnect to a memory bus (with or without a memory controller), a peripheral bus, and a local bus using any of a variety of commercially available bus architectures. The system memory 1706 includes ROM 1710 and RAM 1712. A basic input/output system (BIOS) can be stored in a non-volatile memory such as ROM, erasable programmable read only memory (EPROM), EEPROM, which BIOS contains the basic routines that help to transfer information between elements within the computer 1702, such as during startup. The RAM 1712 can also include a high-speed RAM such as static RAM for caching data.

The computer 1702 further includes an internal hard disk drive (HDD) 1714 (e.g., EIDE, SATA), one or more external storage devices 1716 (e.g., a magnetic floppy disk drive (FDD) 1716, a memory stick or flash drive reader, a memory card reader, etc.) and an optical disk drive 1720 (e.g., which can read or write from a CD-ROM disc, a DVD, a BD, etc.). While the internal HDD 1714 is illustrated as located within the computer 1702, the internal HDD 1714 also can be configured for external use in a suitable chassis (not shown). Additionally, while not shown in environment 1700, a solid state drive (SSD) could be used in addition to, or in place of, an HDD 1714. The HDD 1714, external storage device(s) 1716 and optical disk drive 1720 can be connected to the system bus 1708 by an HDD interface 1724, an external storage interface 1726 and an optical drive interface 1728, respectively. The interface 1724 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1702, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. The systems and methods described herein can be implemented utilizing various commercially available operating systems or combinations of operating systems.

Computer 1702 can optionally comprise emulation technologies. For example, a hypervisor (not shown) or other intermediary can emulate a hardware environment for operating system 1730, and the emulated hardware can optionally be different from the hardware illustrated in FIG. 17. In such an embodiment, operating system 1730 can comprise one virtual machine (VM) of multiple VMs hosted at computer 1702. Furthermore, operating system 1730 can provide runtime environments, such as the Java runtime environment or the . NET framework, for applications 1732. Runtime environments are consistent execution environments that allow applications 1732 to run on any operating system that includes the runtime environment. Similarly, operating system 1730 can support containers, and applications 1732 can be in the form of containers, which are lightweight, standalone, executable packages of software that include, e.g., code, runtime, system tools, system libraries and settings for an application.

Further, computer 1702 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1702, e.g., applied at the application execution level or at the operating system (OS) kernel level, thereby enabling security at any level of code execution.

A user can enter commands and information into the computer 1702 through one or more wired/wireless input devices, e.g., a keyboard 1738, a touch screen 1740, and a pointing device, such as a mouse 1742. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1704 through an input device interface 1744 that can be coupled to the system bus 1708, but can be connected by other interfaces, such as a parallel port, an IEEE 1394 serial port, a game port, a USB port, an IR interface, a BLUETOOTH® interface, etc.

A monitor 1746 or other type of display device can be also connected to the system bus 1708 via an interface, such as a video adapter 1748. In addition to the monitor 1746, a computer typically includes other peripheral output devices (not shown), such as speakers, printers, etc.

The computer 1702 can operate in a networked environment using logical connections via wired and/or wireless communications to one or more remote computers, such as a remote computer(s) 1750. The remote computer(s) 1750 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1752 is illustrated. The logical connections depicted include wired/wireless connectivity to a local area network (LAN) 1754 and/or larger networks, e.g., a wide area network (WAN) 1756. Such LAN and WAN networking environments are commonplace in offices and companies, and facilitate enterprise-wide computer networks, such as intranets, all of which can connect to a global communications network, e.g., the Internet.

When used in a LAN networking environment, the computer 1702 can be connected to the local network 1754 through a wired and/or wireless communication network interface or adapter 1758. The adapter 1758 can facilitate wired or wireless communication to the LAN 1754, which can also include a wireless access point (AP) disposed thereon for communicating with the adapter 1758 in a wireless mode.

When used in a WAN networking environment, the computer 1702 can include a modem 1760 or can be connected to a communications server on the WAN 1756 via other means for establishing communications over the WAN 1756, such as by way of the Internet. The modem 1760, which can be internal or external and a wired or wireless device, can be connected to the system bus 1708 via the input device interface 1744. In a networked environment, program modules depicted relative to the computer 1702 or portions thereof, can be stored in the remote memory/storage device 1752. It will be appreciated that the network connections shown are examples and other means of establishing a communications link between the computers can be used.

When used in either a LAN or WAN networking environment, the computer 1702 can access cloud storage systems or other network-based storage systems in addition to, or in place of, external storage devices 1716 as described above. Generally, a connection between the computer 1702 and a cloud storage system can be established over a LAN 1754 or WAN 1756, e.g., by the adapter 1758 or modem 1760, respectively. Upon connecting the computer 1702 to an associated cloud storage system, the external storage interface 1726 can, with the aid of the adapter 1758 and/or modem 1760, manage storage provided by the cloud storage system as it would other types of external storage. For instance, the external storage interface 1726 can be configured to provide access to cloud storage sources as if those sources were physically connected to the computer 1702.

The computer 1702 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer-readable storage media can include but are not limited to magnetic storage devices (e.g., hard disk, floppy disk, magnetic strips, etc.), optical discs (e.g., compact disc (CD), digital versatile disc (DVD), blu-ray disc (BD), etc.), smart cards, and memory devices comprising volatile memory and/or non-volatile memory (e.g., flash memory devices, such as, for example, card, stick, key drive, etc.), or the like. In accordance with various implementations, computer-readable storage media can be non-transitory computer-readable storage media and/or a computer-readable storage device can comprise computer-readable storage media.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. A processor can be or can comprise, for example, multiple processors that can include distributed processors or parallel processors in a single machine or multiple machines. Additionally, a processor can comprise or refer to an integrated circuit, an application specific integrated circuit (ASIC), a digital signal processor (DSP), a programmable gate array (PGA), a field programmable gate array (FPGA), a programmable logic controller (PLC), a complex programmable logic device (CPLD), a state machine, a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

A processor can facilitate performing various types of operations, for example, by executing computer-executable instructions. When a processor executes instructions to perform operations, this can include the processor performing (e.g., directly performing) the operations and/or the processor indirectly performing operations, for example, by facilitating (e.g., facilitating operation of), directing, controlling, or cooperating with one or more other devices or components to perform the operations. In some implementations, a memory can store computer-executable instructions, and a processor can be communicatively coupled to the memory, wherein the processor can access or retrieve computer-executable instructions from the memory and can facilitate execution of the computer-executable instructions to perform operations.

In certain implementations, a processor can be or can comprise one or more processors that can be utilized in supporting a virtualized computing environment or virtualized processing environment. The virtualized computing environment may support one or more virtual machines representing computers, servers, or other computing devices. In such virtualized virtual machines, components such as processors and storage devices may be virtualized or logically represented.

In the subject specification, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

As used in this application, the terms “component,” “system,” “platform,” “framework,” “layer,” “interface,” “agent,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, computer-executable instructions, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

A communication device, such as described herein, can be or can comprise, for example, a computer, a laptop computer, a server, a phone (e.g., a smart phone), an electronic pad or tablet, an electronic gaming device, electronic headwear or bodywear (e.g., electronic eyeglasses, smart watch, augmented reality (AR)/virtual reality (VR) headset, or other type of electronic headwear or bodywear), a set-top box, an Internet Protocol (IP) television (IPTV), IoT device (e.g., medical device, electronic speaker with voice controller, camera device, security device, tracking device, appliance, or other IoT device), or other desired type of communication device.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

It is to be appreciated and understood that components (e.g., processing unit, processing unit core, processor manager component, device, UE, communication network, core network, RAN, base station, AI component, model, processor component, data store, or other component), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A method, comprising:
analyzing, by a system comprising at least one processor, attribute information relating to a group of attributes relating to conditions associated with a base station; and
controlling, by the system, allocation of respective processing unit cores of a group of processing unit cores associated with the base station for use in performing base station functions based on a result of the analyzing, wherein the result indicates an amount of energy consumption by the base station and indicates whether a quality of service value associated with the base station satisfies a defined threshold quality of service value.

2. The method of claim 1, further comprising:
based on the result of the analyzing, determining, by the system, the conditions associated with the base station; and
based on the conditions, determining, by the system, a number of the respective processing unit cores of the group of processing unit cores that are able to be allocated or respective operational states of the respective processing unit cores that are to be utilized to enable the quality of service value to satisfy the defined threshold quality of service value and enable the base station to have a lower amount of energy consumption than other amounts of energy consumption associated with other numbers of the respective processing unit cores that are able to be allocated or respective other operational states of the respective processing unit cores that are able to be utilized to enable the quality of service value to satisfy the defined threshold quality of service value.

3. The method of claim 2, wherein the respective operational states of the respective processing unit cores comprise respective first operational states of respective first processing unit cores of a first subgroup of the group of processing unit cores, and wherein the method further comprises:
based on the conditions:
determining, by the system, respective quality of service values associated with respective allocations of respective numbers of processing unit cores of the group of processing unit cores or respective second operational states of respective second processing unit cores of respective second subgroups of the group of processing unit cores, wherein the respective second operational states of the respective second processing unit cores of the respective second subgroups comprise the respective first operational states of the respective first processing unit cores of the first subgroup, and wherein the respective numbers comprise the number and the other numbers; and
determining, by the system, respective amounts of energy consumption by the base station that are associated with the respective allocations of the respective numbers of processing unit cores or the respective second operational states of the respective second processing unit cores of the respective second subgroups, wherein the respective amounts of energy consumption comprise the lower amount of energy consumption and the other amounts of energy consumption.

4. The method of claim 1, wherein the quality of service value is a perceived quality of service value associated with a user, and wherein the defined threshold quality of service value is a defined threshold perceived quality of service value.

5. The method of claim 1, wherein the group of attributes comprise or relate to a duplex type associated with communication of data between the base station and a device, an active spectrum associated with the base station, a spectrum utilization associated with the base station, a spectral efficiency associated with the base station, a time to interval associated with the base station, a number of the respective processing unit cores allocated, a level of utilization of the respective processing unit cores, an overall layer 1 latency associated with the base station, respective operational states of respective unallocated processing unit cores of the group of processing unit cores, a frequency associated with the group of processing unit cores, midhaul incoming and outgoing data traffic to and from the base station, a number of devices being scheduled per the time to interval, or a perceived quality of service associated with the base station.

6. The method of claim 1, wherein the analyzing comprises analyzing the attribute information relating to the group of attributes relating to the conditions associated with the base station and previous attribute information relating to the group of attributes relating to previous conditions associated with the base station, wherein the result is a first result, and wherein the method further comprises:
based on a second result of the analyzing of the attribute information and the previous attribute information, determining, by the system, a trend of one or more of the conditions associated with the base station;
based on the trend:
determining, by the system, whether to increase or decrease the allocation of the respective processing unit cores of the group of processing unit cores; or
determining, by the system, whether to modify an operational state of a processing unit core of the group of processing unit cores.

7. The method of claim 6, wherein the processing unit core is able to be configured to be in respective operational states of a group of operational states comprising a lowest operational state, a highest operational state, and a second-highest operational state, wherein the lowest operational state and the second-highest operational state are associated with non-allocation of the processing unit core, wherein the highest operational state is associated with allocation of the processing unit core, and
wherein the lowest operational state is associated with a lowest power consumption by the processing unit core, the highest operational state is associated with a highest power consumption by the processing unit core, and the second-highest operational state is associated with a second-highest power consumption by the processing unit core.

8. The method of claim 6, further comprising:
determining, by the system, that a number of the respective processing unit cores of the group of processing unit cores allocated is to be increased or the operational state of the processing unit core is to be increased to a higher operational state based on the trend indicating that an amount of processing resources of the group of processing unit cores to be utilized by the base station is to be increased to ensure that the quality of service value satisfies the defined threshold quality of service value, wherein the higher operational state is higher than the operational state.

9. The method of claim 6, further comprising:
determining, by the system, that a number of the respective processing unit cores of the group of processing unit cores allocated is to be decreased or the operational state of the processing unit core is to be decreased to a lower operational state based on the trend indicating that decreasing an amount of processing resources of the group of processing unit cores to be utilized by the base station is able to ensure that the quality of service value satisfies the defined threshold quality of service value and is able to reduce the amount of energy consumption by the base station, wherein the lower operational state is lower than the operational state.

10. The method of claim 1, wherein the group of processing unit cores is part of a central processing unit.

11. The method of claim 1, wherein the base station is part of a disaggregated radio access network comprising a distributed unit of the base station, and wherein the group of processing unit cores is associated with the distributed unit.

12. A system, comprising:
at least one memory that stores computer executable components; and
at least one processor that executes computer executable components stored in the at least one memory, wherein the computer executable components comprise:
a condition detector that analyzes attribute data relating to a group of attributes relating to conditions associated with radio access network equipment, and, based on a result of the analysis of the attribute data, determines the conditions associated with the radio access network equipment; and
a processor manager that controls allocation of respective processing unit cores of a group of processing unit cores of at least one processing unit associated with the radio access network equipment for use in performing radio access network functions based on the conditions, wherein the conditions indicate an amount of power consumption by the radio access network equipment and indicate whether a quality of service metric associated with the base station satisfies a defined threshold quality of service metric.

13. The system of claim 12, wherein, based on the conditions, the processor manager determines a number of the respective processing unit cores of the group of processing unit cores that are to be allocated or respective operational states of the respective processing unit cores that are to be configured to enable the quality of service metric to satisfy the defined threshold quality of service metric and enable the radio access network equipment to have a lower amount of power consumption than other amounts of power consumption associated with other numbers of the respective processing unit cores that are able to be allocated or respective other operational states of the respective processing unit cores that are able to be configured to enable the quality of service metric to satisfy the defined threshold quality of service metric.

14. The system of claim 13, wherein the respective operational states of the respective processing unit cores comprise respective first operational states of respective first processing unit cores of a first subgroup of the group of processing unit cores,
wherein, based on the conditions:
the processor manager determines respective quality of service metrics associated with respective allocations of respective numbers of processing unit cores of the group of processing unit cores or respective second operational states of respective second processing unit cores of respective second subgroups of the group of processing unit cores, and
the processor manager determines respective amounts of power consumption by the radio access network equipment that are associated with the respective allocations of the respective numbers of processing unit cores or the respective second operational states of the respective second processing unit cores of the respective second subgroups,
wherein the respective second operational states of the respective second processing unit cores of the respective second subgroups comprise the respective first operational states of the respective first processing unit cores of the first subgroup, wherein the respective numbers comprise the number and the other numbers, and wherein the respective amounts of power consumption comprise the lower amount of power consumption and the other amounts of power consumption.

15. The system of claim 12, wherein the quality of service metric is a perceived quality of service metric associated with a user, and wherein the defined threshold quality of service metric is a defined threshold minimum perceived quality of service metric.

16. The system of claim 12, wherein the group of attributes comprise or relate to a duplex type associated with communication of data between the radio access network equipment and a user equipment, an active spectrum associated with the radio access network equipment, a spectrum utilization associated with the radio access network equipment, a spectral efficiency associated with the radio access network equipment, a time to interval associated with the radio access network equipment, a number of the respective processing unit cores allocated, a level of utilization of the respective processing unit cores, an overall layer 1 latency associated with the radio access network equipment, respective operational states of respective unallocated processing unit cores of the group of processing unit cores, a frequency associated with the group of processing unit cores, midhaul incoming and outgoing data traffic to and from the radio access network equipment, a number of user equipment being scheduled per the time to interval, or a perceived quality of service associated with the radio access network equipment.

17. The system of claim 12, wherein the result is a first result, wherein the condition detector analyzes the attribute data relating to the group of attributes relating to the conditions associated with the radio access network equipment and previous attribute data relating to the group of attributes relating to previous conditions associated with the radio access network equipment,
wherein, based on a second result of the analysis of the attribute data and the previous attribute data, the condition detector determines the conditions and the previous conditions associated with the radio access network equipment,
wherein, based on the conditions and the previous conditions, the processor manager determines a trend with regard to one or more of the conditions associated with the radio access network equipment, and
wherein, based on the trend:
the processor manager determines whether to increase or decrease the allocation of the respective processing unit cores of the group of processing unit cores; or
the processor manager determines whether to adjust an operational state of a processing unit core of the group of processing unit cores.

18. The system of claim 12, wherein the at least one processing unit comprises a general-purpose processor comprising the group of processing unit cores.

19. A non-transitory machine-readable medium, comprising executable instructions that, when executed by at least one processor, facilitate performance of operations, comprising:
evaluating characteristic data relating to a group of characteristics relating to conditions associated with a distributed unit of a radio access network; and
managing utilization of respective processing unit cores of a group of processing unit cores associated with the distributed unit for use in performing radio access network operations based on a result of the evaluating, wherein the result indicates an amount of power consumption by the distributed unit and indicates whether a quality of service measurement associated with the radio access network satisfies a function of a defined threshold quality of service.

20. The non-transitory machine-readable medium of claim 19, wherein the operations further comprise:
based on the result of the evaluating, determining the conditions associated with the distributed unit; and
based on the conditions, determining a number of the respective processing unit cores of the group of processing unit cores that are to be allocated or respective operational states of the respective processing unit cores that are to be utilized to enable the quality of service measurement to satisfy the function of the defined threshold quality of service and enable the distributed unit to have a lower amount of power consumption than other amounts of power consumption associated with other numbers of the respective processing unit cores that are able to be allocated or respective other operational states of the respective processing unit cores that are able to be utilized to enable the quality of service metric to satisfy the function of the defined threshold quality of service.
